(19) United States
(12) Patent Application Publication
(10) Pub. No.: US 2026/0327950 A1
(43) Pub. Date: Oct. 22, 2026

(54) TERRAIN MODIFICATION TRACKING

(71) Applicant: MAKIN APS, Odense M (DK)

(72) Inventor: Lars OVERGAARD, Odense S (DK)

(21) Appl. No.: 19/122,806

(22) PCT Filed: Oct. 19, 2023
(86) PCT No.: PCT/DK2023/050248

§ 371 Date: Apr. 21, 2025

(30) Foreign Application Priority Data
Oct. 19, 2022 (DK) PA 2022 70503

(51) Int. Cl. E02F 9/26; E02F 9/20; G06T 17/05

(52) U.S. Cl. CPC E02F 9/261; E02F 9/2054; E02F 9/264; G06T 17/05

(57) ABSTRACT

The invention relates to a terrain modification tracking method; wherein said method comprises the steps of: providing a plurality of ground modifiers (1a, 1b) each comprising an earthwork tool (4) comprising a tool point (11); repeatedly modifying a terrain having a ground surface using said earthwork tool of said plurality of ground modifiers, to repeatedly establishing a modified terrain comprising a modified ground surface; repeatedly tracking a tool point (11) position of said tool point of each of said plurality of ground modifiers during said step of modifying said terrain, to establish real-time tool point position data of each of said plurality of ground modifiers; repeatedly generate a digital modified ground surface representation (DMGSR) based on said real-time tool point position data of each of said plurality of ground modifiers; repeatedly displaying at least a part of said generated digital modified ground surface representation on at least two displays (23), wherein at least one display of said at least two displays are associated with a ground modifier of said plurality of ground modifiers.

### FIELD OF THE INVENTION

The present invention relates to a terrain modification tracking method, system and apparatus.

### BACKGROUND OF THE INVENTION

Terrain modification is an integral part of construction, and often it lays the foundation for further construction work. E.g., most buildings, roads, bridges etc. are built on top of terrain that has been modified in some way. If the terrain/ground modification at a building site is not carried out properly, it may be detrimental to the rest of the construction work. Thus, time consuming manual inspections are performed to ensure that terrain/ground modifications are carried out properly. Terrain modification projects often involve multiple earthwork machines working on the same site. The projects may include different types of earthwork machines and multiple similar or identical earthwork machines. Therefore, it is difficult for earthwork operators to coordinate their work effort, in turn, decreasing work efficiency and increasing the energy consumption of the working earthwork machines. Moreover, operators performing terrain/ground modifications often remove or replace more ground material than required, to ensure that the work fulfills the decided requirements of the terrain modification project, thereby further increasing material and energy consumption. Altogether, the process of performing proper terrain/ground modification using multiple earthwork machines is highly energy-and time consuming and requires earthwork machine operators to put a lot of effort into coordinating their work instead of performing the actual terrain modification.

### SUMMARY OF THE INVENTION

The invention relates to a terrain modification tracking method; wherein said method comprises the steps of: providing a plurality of ground modifiers each comprising an earthwork tool comprising a tool point; repeatedly modifying a terrain having a ground surface using said earthwork tool of said plurality of ground modifiers, to repeatedly establishing a modified terrain comprising a modified ground surface; repeatedly tracking a tool point position of said tool point of each of said plurality of ground modifiers during said step of modifying said terrain, to establish real-time tool point position data of each of said plurality of ground modifiers; repeatedly generate a digital modified ground surface representation (DMGSR) based on said real-time tool point position data of each of said plurality of ground modifiers; repeatedly displaying at least a part of said generated digital modified ground surface representation on at least two displays, wherein at least one display of said at least two displays are associated with a ground modifier of said plurality of ground modifiers.

The invention provides several advantages. For example, the invention has the effect of providing a digital representation of a terrain modification performed by more than one ground modifier by means of the digital modified ground surface representation. Furthermore, the invention enables people, e.g., operators of earthwork machines to view the digital representation of the terrain modification provided by the digital modified ground surface representation on at least two displays. Thereby, people such as, e.g., operators may be able to obtain an overview of the terrain modification performed by multiple ground modifiers by viewing the digital modified ground surface representation on the two displays. The displays may each be associated with a different ground modifier and hence, each display may be positioned at different locations, while at the same time showing at least a part of the same digital modified ground surface representation representing the modified ground surface of the modified terrain. E.g., the association of the displays with a ground modifiers is advantageous in that it has the effect of, e.g., providing at least one operators of a ground modifier an overview of the work performed by the plurality of ground modifiers directly via a display, e.g., positioned in the ground modifier that the operator is operating, while another operator and or another person such as a project manager may be provided with the same overview on a display positioned in another ground modifier or on a display positioned elsewhere, e.g. in an office backend, or on a tablet utilized by, e.g., a project manager. This is advantageous in that it has the effect that multiple persons involved in a building project are able to observe the terrain modification of the building project as it evolves over time, giving the operators and other relevant persons the ability to efficiently coordinate their work and hence, do a generally more efficient terrain modification work. E.g., instead of operators constantly having to communicate about what earthwork is being performed and when and having to drive around, e.g., a building site to see what work needs to be performed, the invention provide operators the ability to obtain that information via the displayed digital modified ground surface representation and thereby the operators can focus their time and energy on performing the actual terrain modification. Advantageously, by repeatedly generating and displaying the digital modified ground surface representation that represents ground modification performed by a plurality of ground modifiers, it may be possible to observe the terrain modification work progress so fast that it may be perceived as ‘real-time’. In other words, the invention provides a way of constantly following terrain modification work progression of multiple ground modifiers. Thereby, operators of earthwork machines or even other people involved in the terrain modification work, such as, e.g., project managers, may be able to take decisions based on real-time digital representation of the modified ground surface by means of the digital modified ground surface representation.

In the present context, the term earthwork tool may be understood as a tool configured to ground modification. Ground modification may relate to any modification made to a ground of a terrain or any modification made to an already modified ground of a modified terrain. The ground modification may thus, e.g., include moving ground material from one location to another, e.g., by digging and scraping, and it may also include, e.g., compressing ground material. In principle ground modification may relate to any way of modifying a ground of a terrain. Hence follow that the earthwork tool may be of many different types, as long as the earthwork tool is configured to ground modification.

In the present context, tool point may be understood as a representation of, e.g., the size and geometry of an earthwork tool, including the whole geometry of the tool. In preferred embodiments of the invention, the tool point may represent a geometry, including size and shape of a part of an earthwork tool, including, e.g., of the blade of an earthwork tool, which may sometimes also referred to as the cut of the earthwork tool, to name a few non-limiting examples. Hence it should be understood that the tool point may represent a structure and not necessarily merely a point of an earthwork tool. The representation may thus, e.g., comprise multiple digital samples or points. Hence, the tool point should not necessarily be limited to only a point of an earthwork tool, even though the invention may be implemented with a tool point representing a particular point of an earthwork tool.

The term tool point position of each of said ground modifiers may refer to the spatial position of an individual tool point of a ground modifier. The tool point position may change over time as the tool point moves when the ground modifier performs modification of a terrain using the earthwork tool.

Tracking of the tool point position refers to obtaining and/or establishing real-time tool point position data describing the spatial tool point position over time. Hence repeatedly tracking the tool point position may be understood as establishing and/or obtaining the tool point position repeatedly over time.

In the present context a ground surface constitutes a surface of a terrain. The terrain may comprise various kinds of ground material, and it should be understood that in the context of the invention, ground material should be understood in a broad sense. Thereby, ground material may comprise, e.g., soil, clay, sand, gravel, rock, but also various kinds of pavements including, e.g., asphalt and tiles etc. The ground material of a ground surface may also be understood to include vegetation such as, e.g., trees, bushes, grass, and even concrete and objects or parts of objects such as, e.g., buildings. Hence following, that ground and the ground surface and even a modified ground surface may correspondingly comprise such kinds of materials and/or combinations thereof.

In the context of the invention, a modified terrain may be understood as a terrain that has undergone a form of modification so that it is changed with respect to how the terrain was prior to the applied modification. Non-limiting examples of terrain modifications may, e.g., comprise terrain modifications that alters the geometry and/or topology of the terrain and/or of a previously modified terrain, including, e.g., digging, scraping, compressing material of the terrain to name a few. Thus, modifying the terrain may be understood in a broad sense as a process that leads to a modified terrain, meaning that the modified terrain is different compared to the terrain before it was modified. The step of modifying a terrain correspondingly modifies (changes) the ground surface of the terrain into a modified ground surface.

In the present context, the term digital modified ground surface representation may be understood as a digital representation of a modified ground surface of a modified terrain. A digital modified ground surface representation may comprise digital samples that resembles the modified ground surface, and which may be handled and processed by a computing device. These digital samples may comprise various information that may characterize the modified ground surface, including, e.g., elevation obtained for various geographical locations of the modified terrain. Elevation may in the context of the invention be understood as a measure of height, including, e.g., height above sea-level or any other measure of height. A digital modified ground surface representation may also be understood as a representation of what is sometimes referred to with the term an as build surface.

In the present context, the term repeatedly generating should be understood in a broad sense to also include updating said digital modified ground surface representation. Hence, repeatedly generating a digital modified ground surface representation may also, e.g. include updating an existing digital modified ground surface representation. Hence, if a digital modified ground surface representation already exists, the step of generating a digital modified ground surface representation may, e.g., comprise updating the existing digital modified ground surface representation to represent the current modified ground surface. Moreover, the term generating a digital modified ground surface representation may also refer to establishing a new digital modified ground surface representation if a previous digital modified ground surface representation is not already existing.

In the present context, the term based on real-time tool point position data may be understood in a broad sense to include generation of a digital modified ground surface representation based on any data that is derivable from real-time tool point position data from a ground modifier. Hence, the term based on tool point position data of each of said plurality of ground modifiers may in the present context also be understood to include, e.g., generation of the digital modified ground surface by combining multiple digital ground surface representations and/or digital modified ground surface representations of a ground surface and/or modified ground surface from a plurality of ground modifiers, since each of such digital representations may essentially be based on real-time tool point position data. Hence, combining multiple digital modified ground surface representations that is each based on real-time tool point position data may also be understood as a way of generating a digital modified ground surface representation based on real-time tool point position data.

In the present context the physical modification of the terrain may advantageously be automatically measured, e.g., by motion sensors, image detectors, inertial measuring units, joint angle encoders, GNSS, etc., and/or any practical combination thereof enabling an establishment of a digital representation of how a ground modifier with respective earthwork tool(s) physically affects the terrain. The digital representation, e.g. the digital modified ground surface representation, may preferably be performed automatically and on a run-time basis.

The digital modified ground surface representation may, even if measured as mentioned above, be regarded as an estimation rather than an exact representation of the ground surface insofar this estimation is regarded sufficient for providing a usable digital modified ground surface representation.

In the context of the invention, it should be understood that a digital modified ground surface representation may be visually rendered and displayed on one or more displays in a variety of ways within the scope of the invention. This includes, e.g., three dimensional rendering, two dimensional rendering etc. The digital modified ground surface representations and the visual rendering thereof may be updated such that when viewed on, e.g., a display, it creates a visual perception of real-time tracking of the actual physical motion of a tool point moving to modify a terrain.

In the context of the invention the term display may refer to any type of display including any type of monitor, any type of head-up display and any type of projector.

According to an embodiment of the invention, said at least two displays are each associated with a separate ground modifier of said plurality of ground modifiers.

Advantageously, this may have the effect that operators of two different ground modifiers may view at least parts of the digital modified ground surface.

Modifying terrain

According to an embodiment of the invention, said step of repeatedly modifying said terrain comprises lifting ground material from one horizontal location to another horizontal location.

Such lifting procedures may be performed by various ground modifiers, including, e.g., excavators and wheel loaders, to name a few non-limiting examples.

According to an embodiment of the invention, said real-time tool point position data comprises a geographical location and an associated elevation of a tool point position.

In the present context, the term geographical location (sometimes referred to as elevation data) may be understood as a geographical location (sometimes referred to as position) on Earth. The geographical location may, e.g., specify a location of the tool point on the surface of Earth based on a set of coordinates. The coordinates could include latitude and longitude, to name a non-limiting example. GPS data is an example of data comprising geographical location.

Elevation (sometimes referred as elevation data) may in the present context be understood as data representing the height and/or depth at a given geographical location. Elevation may, e.g., be specified relatively, e.g., relative to sea level, e.g., a height above sea level etc. Hence, the tool point position of a tool point may be described by, e.g., three coordinates, wherein two coordinates may represent the geographical location and wherein a third coordinate may specify the elevation at that geographical location.

According to an embodiment of the invention, said real-time tool point position data is determined based on global position information and local position information.

According to an embodiment of the invention, said real-time tool point position data is determined based on a kinematic model utilizing said local position information and said global position information.

Advantageously, this has the effect of enabling accurate determination of the tool point position.

According to an embodiment of the invention, the real-time tool point position data may be determined based on a robotic model.

According to an embodiment of the invention, said global position information is obtained from a global navigation satellite system configured to determine a position of each ground modifier of said plurality of ground modifiers.

Advantageously, this may have the effect of providing relatively accurate global positioning information. It should be understood that global positioning information may comprise a geographical location.

According to an embodiment of the invention, said local position information comprises sensor readings from one or more local positioning sensors, wherein said one or more local positioning sensors is positioned on said each ground modifier of said plurality of ground modifiers.

Advantageously, this may have the effect of providing accurate local position information of the tool point position of each od the plurality of ground modifiers.

According to an embodiment of the invention, said one or more local positioning sensors are configured to detect an elevation of said modified ground surface and/or of said ground surface.

This is advantageous, in that this has the effect that elevation data may be applied to generate a digital modified ground surface representation that represents the elevation of, e.g., a modified ground surface.

According to an embodiment of the invention, said local positioning sensors comprises one or more inertial measuring units positioned on each ground modifier of said plurality of ground modifiers.

Advantageously, this may have the effect of providing accurate measures of the tool point position of each of the plurality of ground modifiers. Inertial measuring units (IMU) are particularly advantageous because these sensors, contrary to, e.g., optical sensors such as cameras and laser based sensors, may handle the rough and dirty environment that ground modifiers operate in. E.g., the lens of optical sensors may become dirty and may thereby start to measure inaccurately or not measure at all, which is highly problematic.

According to an embodiment of the invention, said one or more inertial measuring units are positioned on any one or more major moveable parts of said each ground modifier of said plurality of ground modifiers.

Advantageously, this may have the effect that the inertial measuring unit may provide measures related to the movement of each of the major moveable parts and thereby, the tool point position may be accurately determined based on the data provided by the inertia measuring units. Any major part may refer to any part of the ground modifier that can be actuated to move. Notice, however, that the wheels are typically not included as a major moveable part, since the movement of the wheels to change geographical location of the ground modifiers is measured in other ways, e.g., by global positioning sensors. Hence in the present context, the major moveable parts may typically refer to any part of the ground modifier that may be actuated to provide movement of parts of the ground modifier that does not provide movement of the whole ground modifier from one geographical location to another.

According to an embodiment of the invention, said step of repeatedly generating said digital modified ground surface representation is performed substantially during said step of repeatedly modifying said terrain.

Advantageously, this may have the effect that it is possible to follow the ground modification process substantially while the ground modification is actually performed. A ground modifier operator may, e.g., utilize this as for assisting by viewing a displayed digital modified ground surface representation that is updated substantially in what may be perceived as real-time during, e.g., during the ground modification process. Hence, the operator or other persons may not only being assisted after the working day has ended using a backend generated digital modified surface representation, but may actually utilize the digital modified ground surface representation during the actual ground modification process.

According to an embodiment of the invention, said step of generating said digital modified ground surface representation comprises: generating individual digital modified ground surface representations based on real-time tool point position data for said each ground modifier of said plurality of ground modifiers; and combining each of said individual digital modified ground surface representations into said digital modified ground surface representation.

Advantageously, this may be an efficient way of generating the digital modified ground surface representation. Furthermore, this may have the further effect that the generated individual digital modified ground surface representations may be displayed during, e.g., communication breakdown during which the plurality of ground modifiers may not be able to share data required to generate the digital modified ground surface representation, which is advantageous.

According to an embodiment of the invention, said combining each of said individual digital modified ground surface representations comprises: identifying overlapping surface regions across said individual digital modified ground surface representations; and selecting for each overlapping surface regions elevation data having the lowest elevation to be used for said generation of said digital modified ground surface representation.

Advantageously, this may have the effect that the generated digital modified ground surface representation represents the bottom of cut across the plurality of ground modifiers.

According to an embodiment of the invention, said step of generating said digital modified ground surface representation comprises: combining said real-time tool point position data of each of said plurality of ground modifiers into combined real-time tool point position data; and generating said digital modified ground surface representation based on said combined real-time tool point position data.

Advantageously, this may have the effect that digital modified ground surface representations may be generated without requiring generation of individual digital modified ground surface representation. This may provide an efficient and fast way of generating digital modified ground surface representations, which is advantageous. Notice that a fast generation of digital modified ground surface representation may be particular advantageous when seeking to provide a person viewing the digital modified ground surface representation during ground modification with the perception that the digital modified ground surface representation is generated in real-time during the modification.

According to an embodiment of the invention, said combining said real-time tool point position data comprises: identifying overlapping real-time tool point position data across said real-time tool point position data of each of said plurality of ground modifiers; and selecting among each overlapping real-time tool point position data a real-time tool point position data having the lowest elevation to be used for said combined real-time tool point position data.

Advantageously, this may have the effect of generating a digital modified ground surface representation that represent the bottom of cut of the modified ground surface, which is advantageous. Furthermore, this has the further advantage that this does not require generation of individual digital modified ground surface representation, thereby potentially increasing the speed with which the digital modified ground surface representation may be generated.

Notice that the step of selecting the lowest real-time tool point position data among the overlapping real-time tool point position data may be understood such that in each individual geographical location wherein the real-time tool point position data overlaps, the lowest elevation at that overlapping geographical location is selected. This step is continued for all other overlapping geographical locations of the real-time tool point position data.

According to an embodiment of the invention, each of said individual digital modified ground surface representation is distributed among each of said plurality of ground modifiers.

Advantageously, this may have the effect that the individual digital modified ground surface representation may be utilized to generate digital modified ground surface representation. E.g., generate the digital modified ground surface representation on individual ground modifiers of the plurality of ground modifiers.

According to an embodiment of the invention, said distribution of said individual digital modified ground surface representation comprises only distributing individual digital modified ground surface representations representing a bottom of cut for the ground modifier of said plurality of ground modifiers associated with the individual digital modified ground surface representation being distributed.

Advantageously, this may limit the amount of data transmitted, because only bottom of cut data is distributed.

According to an embodiment of the invention, said each real-time tool point position data of each of said plurality of ground modifiers is distributed among each of said plurality of ground modifiers.

Advantageously, this may have the effect that the real-time tool point position data from each ground modifier of the plurality of ground modifiers may be utilized to generate digital modified ground surface representation. Thereby, each of the plurality of ground modifiers does not need to generate individual digital modified ground surface representations but may instead directly communicate real-time tool point position data.

According to an embodiment of the invention, said distribution of said real-time tool point position data comprises only distributing real-time tool point position data representing a bottom of cut for the ground modifier of said plurality of ground modifiers associated with the real-time tool point position being distributed.

Advantageously, this may limit the amount of data transmitted, because only bottom of cut data is distributed.

According to an embodiment of the invention, said combining each of said individual digital modified ground surface representations into said digital modified ground surface representation is performed on each ground modifier of said plurality of ground modifiers.

This is advantageous in that it has the effect that even if a ground modifier does not receive either one or more individual digital modified ground surface representation and/or one or more of said real-time tool point position data from one or more other ground modifiers, the ground modifier may continue to generate digital modified ground surface representation based on the received data. Hence, the ground modifier may continue generating and viewing a digital modified ground surface representation even in case other ground modifiers may not supply data. A further advantage is that the ground modifier is not depending on a remote computing device to generate the digital modified ground surface representation and hence, even in case of, e.g., a network failure, ground modifiers are at least always capable of repeatedly generating digital modified ground surface representations based on its own real-time tool point position data.

According to an embodiment of the invention, said repeatedly generate a digital modified ground surface representation is performed on said each ground modifier of said plurality of ground modifiers.

This may have the advantage that the generated digital modified ground surface representation may not need to be distributed among ground modifiers and/or a data server and/or from an external surface determination module to each ground modifier.

According to an embodiment of the invention, upon re-establishment of data communication between said plurality of ground modifiers; said digital modified ground surface representation is automatically updated based on newest real-time tool point position data from said plurality of ground modifiers.

Advantageously, this may have the effect of re-establishing the digital modified ground surface representation after a communication breakdown wherein data may not have been shared among the ground modifiers and/or among the ground modifiers and a data server. Data loss during transmission of data may occur. Advantageously, the digital modified ground surface representation may be established based on data available and may be updated or freshly generated as more data becomes available.

According to an embodiment of the invention, said digital modified ground surface representation is generated based on real-time tool point position data representing a bottom of cut.

The term bottom of cut may in the present context be understood as the deepest elevation that a tool point has reached on a given location during the step of repeatedly modifying a terrain. The location being a location on the surface of the earth, whereas the elevation describes the depth into the terrain that an earthwork tool has reached.

The blade of the earthwork tool may thus represent the current deepest point at any given location whereat the terrain has been modified.

According to an embodiment of the invention, said digital modified ground surface representation comprises elevation data of a plurality of geographical locations, wherein said elevation data is a representation of elevation at geographical locations of said modified ground surface.

According to an embodiment of the invention, said elevation data of said digital modified ground surface representation is only updated based on real-time tool point position data having a lower elevation than previously established real-time tool point position data.

According to an embodiment of the invention, said method comprises a step of comparing an elevation of each geographical location of said real-time tool point position data obtained from each ground modifier of said plurality of ground modifiers to determine real-time tool point position data comprising the lowest elevation in each geographical location; wherein said digital modified ground surface representation is established based on said determined real-time tool point position data comprising the lowest elevation in each geographical location.

This is advantageous in that the digital modified ground surface representation may thereby represent a bottom of cut of the modified terrain even if the digital modified ground surface representation is generated based on data from a plurality of ground modifiers performing ground modification.

According to an embodiment of the invention, said step of repeatedly generating said digital modified ground surface representation comprises a step of updating said digital modified ground surface.

According to an embodiment of the invention, said digital modified ground surface representation is updated only at geographical locations represented in the said digital modified ground surface representation having an elevation that is higher than an elevation of a corresponding geographical location of said real-time tool point position data based on which the digital modified ground surface representation is updated.

This is advantageous in that the update of the digital modified ground surface representation results in an updated digital modified ground surface representation that represent a bottom of cut of the modified terrain, even if the digital modified ground surface representation is updated based on data from a plurality of ground modifiers performing ground modification.

According to an embodiment of the invention, said step of updating said digital modified ground surface representation comprises identifying geographical locations of said digital modified ground surface that is associated with an elevation being higher compared to an elevation at a corresponding geographical locations of any of said real-time tool point position data of said plurality of ground modifiers; and updating said identified geographical locations of said digital modified ground surface representation with a lowest elevation at a corresponding geographical location selected from any of said real-time tool point position data of any of said plurality of ground modifiers.

Advantageously, this may have the effect that the digital modified ground surface representation reflects a bottom of cut of a modified ground surface of a modified terrain across all the plurality of ground modifiers that has been working to modify said terrain. The bottom of cut is thus reflected by the deepest (lowest) elevation point in a given geographical location that a tool point of any of the plurality of ground modifiers have been. When, e.g., a ground modifier continues earthwork such as digging at a geographical location whereat a first ground modifier has already been digging to modify the terrain, the digital modified ground surface representation first reflect the work performed by the first machine, and the digital modified ground surface may then be updated when the new ground modifier starts digging even deeper than the first ground modifier at the same geographical location. Thereby, the digital modified ground surface representation may always represent the bottom of cut of a terrain or modified terrain even if multiple ground modifiers cooperate in the process of modifying the terrain, which is advantageous.

According to an embodiment of the invention, said method comprises a step of comparing real-time tool point position data obtained from each of said plurality of ground modifiers to select the real-time tool point position data comprising the lowest elevation in each geographical location; and wherein said digital modified ground surface representation is generated based on said lowest elevation in each geographical location.

Advantageously, this may have the effect that the digital modified ground surface representation represents a bottom of cut of the modified ground surface even if it is generated based on data from a plurality of ground modifiers.

According to an embodiment of the invention, said step of updating said digital modified ground surface representation is only carried out when said modified ground surface and/or said ground surface is modified in a vertically downward direction.

Advantageously, the moving direction of a tool point may be identified and furthermore the elevation of the tool point position may be compared to elevation data of the digital modified ground surface representation in corresponding geographical locations. Advantageously, this may have the effect that the digital modified ground surface is updated in an efficient way by only updating when a tool point utilized for ground modification actually modifies a terrain such that the terrain or modified ground surface of the terrain is modified to have a lower bottom of cut (lower elevation). Thereby, advantageously the digital modified ground surface representation may also represent the bottom of cut of the modified terrain.

According to an embodiment of the invention, said vertically downward direction is a direction having at least a directional component corresponding to the direction of the gravitational pull.

It should be understood that the term vertically downward direction may refer to a direction having at least a component corresponding to the direction of gravity. This, e.g., may refer to only updating the digital modified ground surface when a ground modifier is digging deeper in the terrain and/or modified terrain and thereby the ground surface or an already modified ground surface is modified to have a lower elevation. As a non-limiting explanatory example, updating the digital modified ground surface representation may, e.g., occur when a hole is being dug deeper. Further, in this regard, it may be appreciated that the direction of gravity is toward the center of Earth.

It should be understood that in the present context the term only carried out should be understood as the update not being caried out when the modification of the ground surface and/or the modified ground surface is not in a vertical downward direction. Hence, as a non-limiting explanatory example, when filling a hole that is represented by a digital modified ground surface representation with material such that the modified surface associated with the hole is modified to a modified ground surface having a larger elevation, the digital modified ground surface representation may not be updated.

According to an embodiment of the invention, said digital modified ground surface representation comprises a plurality of grid points (27); and wherein said plurality of grid points each represents an area of said modified ground surface (14).

According to an embodiment of the invention, said plurality of grid points (27) comprises elevation data associated with a real-time tool point position data from at least two different ground modifiers of said plurality of ground modifiers.

According to an embodiment of the invention, said grid points of said digital modified ground surface representation (26, DMGSR) comprises a set of geodetic coordinates.

In the context of the invention, geodetic coordinates refer to global coordinates specifying a geographical location, and each of the global coordinates further comprises elevation data (sometimes referred to as elevation). The coordinates thereby may describe a position/location in three dimensions. E.g. a geographical location and elevation. Elevation may, e.g., specify a height above and/or below the sea level. Thereby, the digital modified ground surface representation may be considered a grid structure which is indexed according to the global coordinates.

According to an embodiment of the invention, said each individual grid point (27) of said plurality of grid points has a grid size of less than 5 square meter, such as less than 4 square meters, such as less than 2 square meters, such as less than 1 square meter, such as less than 0.5 square meter, such as less than 0.3 square meter; such as less than square 0.2 square meter., such as less than 0.1 square meter, such than less than 0,05 square meter, such as less than 0.02 square meter, such as less than 0.01 square meter.

According to an embodiment of the invention, said digital modified ground surface representation (26, DMGSR) is subdivided into one or more grid tiles (28a-28d) each representing an area of a terrain and/or modified terrain (14).

Advantageously, this may have the effect that it enables data processing including, e.g., updating of a digital modified ground surface representation, to be performed on one or more grid tiles, rather than on the full digital modified ground surface representation

According to an embodiment of the invention, a size of said one or more grid tiles (28a-28d) are larger than a size of a grid point (27) of said plurality of grid points.

According to an embodiment of the invention, each individual grid tile (281-28d) of said one or more grid tiles represents less than 300 square meter terrain, such as less than 200 square meter terrain, such as less than 150 square meter terrain, such as less than 100 square meter terrain, such as less than 80 square meter terrain, such as less than 50 square meter terrain, such as less than 30 square meter terrain, such as less than 10 square meter terrain, such as less than 5 square meter terrain.

According to an embodiment of the invention, said digital modified ground surface representation (26, DMGSR) is stored as an indexed raster representation.

Advantageously, this may enable fast and efficient update of at least parts or of the whole digital modified ground surface representation.

According to an embodiment of the invention, said digital modified ground surface representations is stored as a vector based representation.

According to an embodiment of the invention, said tool point is represented by a plurality of grid points in said digital modified ground surface representation.

Advantageously this may have the effect that a tool point with a size that is larger than an geographical area represented by a grid point of said digital modified ground surface may be more accurately represented by the grid points, and thereby a modified ground surface modified using the tool point may be more accurately represent by the digital modified ground surface representation.

According to an embodiment of the invention, an update frequency determines the frequency with which said step of generating said digital modified ground surface representation (26, DMGSR) is performed and/or the frequency with which said digital modified ground surface representation (26, DMGSR) is displayed.

According to an embodiment of the invention, said update frequency is at least every fifth hour, such as at least every hour, such as at least every minute, such as at least every 10 seconds, such as at least every 5 seconds, such as at least every 2.5 seconds such as at least every 2 seconds such as at least every 1.5 second, such as at least every 0.5 second such as preferably at least once every second, such as at least every 50 milli seconds or faster.

Advantageously, a fast update frequency may have the effect that the digital modified ground surface representation may follow the process of ground modification closely. Moreover, a fast update frequency may also have the effect that persons viewing a repeatedly displayed repeatedly generated digital modified ground surface may perceive the digital modified ground surface representation as a real-time representation of the ground modification being performed.

According to an embodiment of the invention, said method comprises a step of establishing a digital representation of said ground surface (15) to obtain a digital ground surface representation.

Advantageously, the digital ground surface representation may be utilized as a baseline that may be utilized to evaluate work flow progress. Furthermore, the digital ground surface representation may also provide an initial overview of a terrain, which is advantageous.

According to an embodiment of the invention, said tool point position is only tracked when an elevation of said tool point is below said digital ground surface representation.

Advantageously, this has the effect of limiting the amount of collected data. Furthermore, by only tracking the tool point position when it is below a digital ground surface, the digital modified ground surface representation generated from such data only comprise data collected below the ground surface, which is advantageous, since actual ground modification of the terrain is only performed when the tool point is at or below the ground surface and not when the tool point is above the ground surface represented by the digital modified ground surface representation.

According to an embodiment of the invention, said digital modified ground surface representation is only generated based on real-time tool point position data with an elevation below said digital ground surface representation.

Advantageously, this has the effect that it enables the generated digital modified ground surface representation to only comprise data below the ground surface, which is advantageous, since actual ground modification of the terrain is only performed when the tool point is at or below the ground surface and not when the tool point is above the ground surface represented by the digital modified ground surface representation. Notice that this enables the tool point position of the plurality of ground modifiers to still be tracked. Advantageously, the tracked tool point positions may be utilized to, e.g., display the tool point position on the displays even when the tool point is above the digital ground surface.

According to an embodiment of the invention, said step of repeatedly displaying at least a part of said generated digital modified ground surface representation comprises only displaying part of said digital modified ground surface representation with an elevation below said digital ground surface representation.

Advantageously, this has the effect that only the part of the generated digital modified ground surface representation that is below the ground surface is displayed. This is advantageous, since a digital modified ground surface representation with elevation data above the digital ground surface does not represent the actual modified ground surface.

According to an embodiment of the invention, said method comprises a step of generating digital modified ground surface labels by labeling each geographic location of said digital modified ground surface representation according to a ground modifier of said plurality of ground modifiers that performed said ground modification at said geographic location represented by said digital modified ground surface representation to generate digital modified ground surface labels.

According to an embodiment of the invention, said labeling each geographic location of said digital modified ground surface representation is based on labelled real-time tool point position data; and wherein said labelled real-time tool point position data is generated by labeling said real-time tool point position according to the ground modifier of said plurality of ground modifiers being associated with said real-time tool point position.

Advantageously this may have the effect that it is possible to identify each of the actual ground modifiers that performed the ground modification that led to the modified ground surface represented by the digital modified ground surface representation.

According to an embodiment of the invention, said displaying said digital modified ground surface representation comprises color-coding said digital modified ground surface according to said digital modified ground surface labels.

Advantageously this has the effect of providing a visual reading of which ground modifier that modified the modified ground surface represented by the displayed digital modified ground surface representation.

According to an embodiment of the invention, said method comprises a step of automatically logging data to generate a data log comprising logged data; wherein said data is associated one or more ground modifiers of said plurality of ground modifiers and wherein said data includes at least said real-time tool point position data and/or said digital modified ground surface.

In the present context data may be understood as any data, and the data being associated with one or more ground modifiers may be understood as any data generated by one or more ground modifier(s) of the plurality of ground modifiers and also any data which is associated with the terrain and/or with the modified terrain, including. Hence, data should be understood to include, e.g., digital modified ground surface representation and/or any type of data generated based on tool point position data such as real-time tool point position data. Data may also comprise other data, such as weather data related to the location of a ground modifier and/or tool point position, ground material type data, ground modifier identification data, time related data such as timestamps, operator related data, data related to earthwork tool type used during ground modification etc., to name a few nonlimiting examples of data.

The term logged data may refer to any data that has been logged into the data log.

In the context of the invention, the term automatically refers to the process of logging being automatically performed. Hence, the step of automatically logging data does not require manual logging. This is advantageous, in that an operator of a ground modifier does not need to log data. Also, it enables the operator to focus on performing terrain modification instead of using capacity on logging data.

Automatically logging of data may also be understood as the process of storing data without manually having to initiate and/or performing the storage when the method of the invention is already initiated. In other words, when relevant data for logging, such as, e.g., a digital modified ground surface representation, has been established and/or generated according to the method of the invention, the storing of the data, e.g., the digital modified ground surface representation, is carried out without having to manually initiate and/or performing the storing.

According to an embodiment of the invention, said method comprises a step of logging data including said real-time tool point position data to generate a data log comprising logged real-time tool point position data.

Advantageously, this may have the effect of enabling inspection of terrain modification work performed by a plurality of machines at any time based on the logged real-time tool point position data. Also advantageous, the logged real-time tool point position data may be utilized as documentation of the performed terrain modification. Furthermore, the documentation of the terrain modification could also be established by generating a digital modified ground surface representation based on the logged real-time tool point position data.

According to an embodiment of the invention, said method data comprises a step of logging data including said digital modified ground surface representation to generate a data log comprising logged digital modified ground surface representation data.

Advantageously, the data log may be utilized as documentation of the performed terrain modification. A further advantageous, this may enable inspection of terrain modification work performed by a plurality of machines at any time based on the data log comprising the logged digital modified ground surface representation data.

According to an embodiment of the invention, said data is only logged into said data log when said data is different compared to said logged data included in said data log and/or when said data is not already included in said data log.

According to an embodiment of the invention, logged digital modified ground surface representation data is only updated when said generated digital modified ground surface representation is different to said already logged digital modified ground surface representation data.

In the present context, the term updated may be understood as replacing logged data such as the logged digital modified ground surface representation data with data including generated digital modified ground surface representation.

According to an embodiment of the invention, said data log comprising logged real-time tool point position data is only updated when said real-time tool point position data is different to said logged real-time tool point position data.

Advantageously, logging only when data is different to logged data may have the effect of limiting the data size of the data log, while ensuring that all relevant data that is different to existing data is logged.

According to an embodiment of the invention, said logging of said real-time tool point position comprises only logging a difference between logged real-time tool point position data and said real-time tool point position data.

According to an embodiment of the invention, said logging of said generated digital modified ground surface representation comprises only logging a difference between logged digital modified ground surface representation data and said generated digital modified ground surface representation.

According to an embodiment of the invention, said data log is stored on a data server.

According to an embodiment of the invention, said data server is a remote server located externally with respect to said plurality of ground modifiers.

Advantageously, this may have the effect that the data log may be stored in a safe and secure location suitable for data storage, as opposed to being positioned on a ground modifier that potentially operates in a rough environment.

According to an embodiment of the invention, said steps of logging comprises only transmitting a difference between logged data and new data to said data log.

Advantageously, this may have the effect of limit the amount of data transmitted to the data log. This may be particular advantageous, when the data log is stored remotely with respect to, e.g., a plurality of ground modifiers that generate at least some of the data that is logged in the step of logging. Also, limiting the amount of transmitted data may decrease the energy consumption required for logging and it may also decrease the load on the network used for transmitting the data.

According to an embodiment of the invention, said tool point represents a blade of said earthwork tool.

In the present context, the term blade of an earthwork tool may be understood as the edge of the tool that typically contacts the ground surface or modified ground surface of a terrain first when performing a ground modification operation of the terrain, such as, e.g., digging and scraping. Furthermore, the blade of an earthwork tool may typically represent the actual cut made into the ground during, e.g., a digging operation. Hence, by tracking the blade of an earthwork tool, e.g., tracking the tool point position, it is possible to track the actual ground modification performed by a ground modifier comprising the earthwork tool. Further notice that the tool point may have different shapes, which may be represented digitally. Thereby, as the tool point moves, the shape of the blade and its size may be taken into account when generating the digital modified ground surface representation.

According to an embodiment of the invention, said displaying at least a part of said generated digital modified ground surface representation is performed substantially simultaneously.

Advantageously, this may have the effect that persons viewing the displays views substantially at least a part of the same digital modified ground surface representation. Thereby, the persons are capable communicating or performing earthwork, coordination work, or project managing work on the basis of the same knowledge—the same digital modified ground surface representation.

Advantageously, the digital modified ground surface representation may be visualized in a multitude of ways including 2D and/or 3D representations on a display. E.g., including the exemplified display comprised of the ground modifier illustrated in any of the figures of the present application. In this context it should generally be noted that the displaying on the particular user interface, e.g. at tablet or a stationary interface located in or at the ground modifier, may facilitate that a user selects one or several possible rendering methods in order to fit the current desired purpose well. This is in particular relevant when the digital representation of what the ground modifier is doing to the terrain is (in particular when the model is updated on the basis of bottom of cut) updated in real-time. In that way it will be possible for the user of the ground modifier to be efficiently guided and assisted on a realtime basis. It should also be noted generally, that a visual representation may be performed at a given display on a given assumption that the user interface is related to a particular ground modifier. This coupling of identity may e.g. be done by a user of the user interface or it may be prestored in the user interface as a default, thereby automatically providing a relevant (to the particular ground modifier) displaying of the current digital modified ground surface representation at the user. In this way it is also possible to have at plurality of user interfaces, e.g. each being associated or facilitated to be associated to different ground modifiers and thereby allow all ground modifiers to work on the same digital modified ground surface representation and moreover allow the users of the ground modifiers to view different parts of the digital modified ground surface representation, the different parts being relevant for the users of the respective ground modifier. And this viewing may advantageously be updated in realtime to the degree it is possible.

According to an embodiment of the invention, said displaying is performed synchronously between at least two displays of said plurality of displays.

According to an embodiment of the invention, said displaying a part of said digital modified surface representation on a display associated with a ground modifier comprises displaying a part of said digital modified ground surface representation according to a geographical location of said ground modifier.

Advantageously, this may enable a display associated with a ground modifier to display the most relevant part of the digital modified ground surface representation. E.g., the part being close to the particular ground modifier and not necessarily the parts located further away, e.g., on another part of a building site whereat the ground modifier is provided.

According to an embodiment of the invention, said part of said digital modified ground surface representation displayed on a display associated with a ground modifier extends in a predefined horizontal radius outwards from the location of the ground modifier.

The term horizontal radius may be understood to also include other shapes that a circle. Hence, the term horizontal radius also includes illustrating part of the digital modified ground surface representation extending outwards from the ground modifier forming a different shape than a circle. In the present context, the extending in a horizontal radius outwards from the location of the ground modifier refers to extending away horizontally from the ground modifier along a plane defined by e.g. geographical coordinates.

According to an embodiment of the invention, said predefined radius may be manually selected on a user interface of said ground modifier associated with said display.

This is advantageous in that it may enable the operator to view the part of the digital modified ground surface representation that the user may fine most useable at any particular time. This may increase productivity of the earthwork by providing improved visualization of the digital modified ground surface representation.

According to an embodiment of the invention, said predefined radius is at least between 1 meter to 10 meter, such as at least between 10 meter to 20 meter, such as at least between 20 meter to 50 meter, such as at least 50 meter, such as at least 100 meter such as at least between 1 meter to 500 meter, such as at least between 1 meter to 1000 meter.

According to an embodiment of the invention, said at least a part of said digital modified ground surface may be different among said at least two displays.

According to an embodiment of the invention, said at least a part of said digital modified ground surface may be displayed on a display associated with a ground modifier according to a view angle, wherein said view angle depends on the position of the tool point of the ground modifier.

Advantageously, this may have the effect that the operator may view at least a part of the digital modified ground surface representation at a certain view angel of the digital modified ground surface representation depending on the tool point position of the ground modifier. E.g., when a ground modifier rotates its tool point, the view angle of the displayed at least a part of said digital modified ground surface representation may change accordingly.

According to an embodiment of the invention, said view angle may be selected by an operator of said ground modifier associated with said display.

This is advantageous in that it may enable the operator to view the digital modified ground surface or part of the digital modified ground surface at a desired view angle. This may increase productivity of the earthwork by providing improved visualization of the digital modified ground surface representation.

According to an embodiment of the invention, a digital representation of one or more of said plurality of ground modifiers may be visualized at their geographical location on the digital modified ground surface.

Advantageously, this enables persons viewing a display showing the digital modified ground surface representation to also view the position of the ground modifiers working on the given terrain.

The invention relates to a terrain modification tracking system; wherein said terrain modification tracking system comprises: a plurality of ground modifiers, wherein said plurality of ground modifiers each comprises: a ground modification arrangement comprising an earthwork tool having a tool point; a tool point localizing module(s) configured to repeatedly establish real-time tool point position data of a tool point position of said tool point; said terrain modification tracking system further comprises: a surface determination module (21) configured to generate a digital modified ground surface representation (26, DMGSR) based on said real-time tool point position data of each ground modifier of said plurality of ground modifiers; a plurality of displays configured to display said digital modified ground surface representation (26, DMGSR), wherein a first display of said plurality of displays is associated with a first ground modifier of said plurality of ground modifiers.

The terrain modification tracking system may provide the same advantages described in relation to the discloses terrain modification tracking method.

The term associated with may be understood as the display being paired or registered with/to ground modifier. Automatically or manually. It may also be understood as the display being arranged to be part of said ground modifier, e.g. arranged in the cab of a ground modifier. The display may be moveable or fixed in the ground modifier.

According to an embodiment of the invention, a second display of said plurality of displays is associated with a second ground modifier of said plurality of ground modifiers.

According to an embodiment of the invention, said system is configured to perform said method according to any of the claims 1-74.

According to an embodiment of the invention, each of said plurality of ground modifiers includes said surface determination module.

Advantageously this may have the effect that each of said plurality of ground modifiers may generate a digital modified ground surface representation. Hence, ground modifiers are not dependable on a remote surface determination module to generate and transmit the digital modified ground surface representation to them. This is advantageous, since a transmission may be prone to error or may result in latency. Furthermore, the digital modified ground surface may even be generated on each ground modifier even if some data such as, e.g., tool point position data from other ground modifiers are not received, which is advantageous. Thereby, a ground modifier may at least be able to generate a digital modified ground surface based on real-time tool point position data associated with that particular ground modifier, even if real-time tool point position data or, e.g., one or more individual digital modified ground surface representations are not received from other ground modifiers of the plurality of ground modifiers.

According to an embodiment of the invention, said surface determination module comprises a surface combinator.

This is advantageous in that it enables generation of digital modified ground surface representation based on individual digital modified ground surface representation received, e.g., from one or more other ground modifiers.

In the context of the invention, a surface combinator may be understood as a module configured to combine individual digital modified ground surface representations into a digital modified ground surface representation. The individual digital modified ground surface representations may be generated on surface determination modules of other ground modifiers and/or from a central surface determination module based on real-time tool point position data received from one or more ground modifiers.

According to an embodiment of the invention, said surface combinator is configured to combine individual digital modified ground surface representations into said digital modified ground surface representation.

According to an embodiment of the invention, said combining each of said individual digital modified ground surface representations comprises: identifying overlapping surface regions across said individual digital modified ground surface representations; and selecting for each overlapping surface regions elevation data having the lowest elevation to be used for said digital modified ground surface representation.

According to an embodiment of the invention, said surface determination module comprises a tool point position combinator.

Advantageously, the tool point combinator may combine tool point positions received from a plurality of sources such as from a plurality of ground modifiers. The tool point position combinator may then produce combined real-time tool point position data, which may be used to generate a digital modified ground surface representation, which thereby may represent a modified ground surface modified by the plurality of ground modifiers that may supply the real-time tool point position data.

According to an embodiment of the invention, said tool point combinator is configured to combine real-time tool point position data of said plurality of ground modifiers into combined real-time tool point position data.

According to an embodiment of the invention, said combining said real-time tool point position data of said plurality of ground modifiers comprises: identifying overlapping real-time tool point position data across said real-time tool point position data of each of said plurality of ground modifiers; and selecting among each overlapping real-time tool point position data a real-time tool point position data having the lowest elevation to be used for said combined real-time tool point position data.

Advantageously, this may have the effect that the digital modified ground surface representation may represent a bottom of cut of a modified ground surface modified by the plurality of ground modifiers from which the tool point position data is obtained.

According to an embodiment of the invention, said system comprises a receiver configured to receive at least said real-time tool point position data and/or individual digital modified ground surface representations and/or said digital modified ground surface representation.

According to an embodiment of the invention, said system comprises a transmitter configured to transmit at least said digital modified ground surface representation and/or individual digital modified ground surface representations and/or real-time tool point position data.

According to an embodiment of the invention, said plurality of ground modifiers comprises said receiver and said transmitter.

Advantageously, this enables the ground modifiers to communicate. It may also enable the ground modifiers to communicate with a data servers and other computing devices, which may be advantageous.

According to an embodiment of the invention, said surface determination module comprises said receiver and said transmitter:

Advantageously, this may have the effect that ground modifiers comprising said surface determination module may be able to share tool point position data and/or individual digital modified ground surface representations and/or digital modified ground surface from various ground modifiers. The sharing of real-time tool point position data and/or of individual digital modified ground surface representations enable a receiving surface determination module to generate the digital modified ground surface based on these shared data, which is advantageous. Furthermore, the sharing of said digital modified ground surface enables receivers of the digital modified ground surface to, e.g., utilize it for displaying. A further advantage is that it enables the surface determination module to be used as a centralized module that determine the digital modified ground surface representation based on the mentioned data received from a plurality of ground modifiers and further it enables transmitting the digital modified ground surface representation to the plurality of ground modifiers. Thereby, the ground modifiers does not need to have a surface determination module on board, which is advantageous.

According to an embodiment of the invention, said surface determination module is located external to any of said plurality of ground modifiers.

Advantageously, this may have the effect that the surface determination module may be protected vibrations caused by a working ground modifier.

Furthermore, an externally located surface determination module may advantageously be utilized as a centralized module that receives real-time tool point position data from said plurality of ground modifiers and generates the digital modified ground surface representation based on these data and then transmits said the digital modified ground surface representation back to the plurality ground modifiers. Thereby, each ground modifier of the plurality of ground modifiers may not need a surface determination module onboard. Thereby, the system may be build with less materials and with less energy spend. Furthermore, this may have the effect of reducing energy consumption, since generation of the digital modified ground surface representation may not need to be performed on each of the plurality of ground modifiers.

According to an embodiment of the invention, said plurality of ground modifiers (1) comprises one or more ground elevation sensors configured to detect elevation of a ground surface (15) and/or of a modified ground surface; and wherein a geographical location of said elevation is registered together with said elevation.

Advantageously, this may have the effect that the elevation of the modified ground surface and/or of the ground surface may be determined directly instead of being determined based on tracking of a tool point position.

In the context of the invention, the ground elevation sensor could be any sensor capable of obtaining elevation data. Hence, the elevation sensor may, e.g., include a LiDAR sensor, a camera a sound based sensor etc., to name a few non-limiting examples.

According to an embodiment of the invention, said elevation and said geographical location is registered as real-time tool point position data.

Advantageously, this may have the effect that the generation of the digital modified ground surface may be based on elevation data obtained with one or more elevation sensors.

In the context of the invention, real-time tool point position data may be understood as data that reflects elevation at a geographical location of a ground surface or of a modified ground surface. Hence, real-time tool point position data may in the present context also include the elevation at a geographical location when the elevation is obtained by a elevation sensor. However, in a preferred embodiment of the invention, the real-time tool point position data represents actual tracked tool point position as this represents a robust way of tracking a tool point and thereby obtaining information about a modified ground surface without risking a camera being damaged, being compromised by dirt on the lens, etc.

According to an embodiment of the invention, each ground modifier of said plurality of ground modifiers comprises: a wheelbase (2); a ground modification arrangement (4); one or more local positioning sensors (12a-12n) configured to provide local positioning information of a tool point position (11) of each said ground modifier (1); and a global positioning arrangement (6a-6b) configured to provide global positioning information of said ground modifier (1).

According to an embodiment of the invention, said global positioning arrangement (6a,6b) comprises one or more global navigation satellite system receivers (18) configured to obtain global position information of each of said one or more ground modifiers (1) based on a global navigation satellite system.

Advantageously this may have the effect of providing accurate global position information of each of the ground modifiers.

According to an embodiment of the invention, said global positioning arrangement (61,6b) comprises at least two global navigation satellite system receivers (18).

Advantageously this may have the effect of increasing the accuracy of the global position information determined for each ground modifier.

According to an embodiment of the invention, said real-time tool point position data is based on local position information received from the local positioning arrangement (12a-12n) and based on global position information received from the global positioning arrangement (6a-6b).

According to an embodiment of the invention, said ground modifier is an excavator.

According to an embodiment of the invention, said excavator further comprises: a motor; a transmission; a body portion (3) comprising a cab (5); wherein said ground modification arrangement (4) is moveably fixated to said body portion (3) and wherein said ground modification arrangement (4) comprises: a boom (7); an arm (8) moveably mounted to an end of said boom (7); and a bucket (9) moveably mounted to an end of said arm (8).

According to an embodiment of the invention, said local positioning sensors is inertial measuring units.

Advantageously, inertial measuring units provide position information that may be used to determine a tool point position. Inertial measuring units are robust and their measuring capabilities are not compromised by dirt, which may be the case by, e.g., optical sensors.

According to an embodiment of the invention, at least one inertial measuring unit of said inertial measuring units are positioned on said boom and/or on said arm and/or on said bucket and/or on said body portion.

According to an embodiment of the invention, said inertial measuring unit is positioned on any one or more moving parts of said ground modification arrangement (4).

According to an embodiment of the invention, said terrain modification tracking system comprises a data server (22) connectable to a network, and wherein said data server is configured to store said digital modified ground surface representation (26, DMGSR) in a data log.

Advantageously, this may have the effect that the data log may be utilized to document the actual earthwork being performed. The data log may thereby provide evidence of the work being performed, e.g., which may be advantageous to provide during, e.g. inspection of an earthwork related project.

According to an embodiment of the invention, said server may be communicatively coupled with said displays of said ground modifiers.

Advantageously, this may enable the display to display information from the data server, including, e.g. digital modified ground surface representations.

According to an embodiment of the invention, said server may be communicatively coupled with said surface determination module.

According to an embodiment of the invention, said data server is a cloud server.

According to an embodiment of the invention, said data server comprises a surface determination module.

This is advantageous in that it enables the data server to generate digital modified ground surface representations. This may further enable the data server to function as a centralized unit that may receive data from ground modifiers, and generate digital modified ground surface representations based on the received data and then transmit the digital modified ground surface representations back to, e.g., the ground modifiers or to one or more other displays.

According to an embodiment of the invention, said first display is arranged on said first ground modifier; and wherein said second display is arranged on said second ground modifier.

According to an embodiment of the invention, said displays are synchronized with respect to the visualization of said digital modified ground surface representations.

According to an embodiment of the invention, said plurality of displays are configured to display at least a part of said digital modified ground surface representation substantially simultaneously.

According to an embodiment of the invention, said system may comprise a user interface configured to enable manual selection of view angle.

Advantageously, this enables a user to select a desired view angle of the digital modified ground surface representation.

The user interface may also enable a user to manipulate the view of the displayed digital modified ground surfacer representation. E.g., manipulating by, e.g. zooming in and/or out on parts of a displayed digital modified ground surface representation.

### THE DRAWINGS

Various embodiments of the invention will in the following be described with reference to the drawings where

FIG. 1-4 illustrate different ways of applying multiple ground modifiers in a terrain modification tracking system within the scope of the invention,

FIG. 5 illustrates an example of a grid,

FIG. 6 illustrates a 3D grid tile,

FIG. 7 illustrates a workflow of terrain modification performed by two ground modifiers,

FIG. 8a-c illustrate a combining of individual digital modified ground surface representations into a digital modified ground surface,

FIG. 9a-9e illustrates snapshots at multiple times of digital modified ground surface representations,

FIGS. 10 and 11 illustrate views of a ground modifier with a positioning arrangement which may be applied in a system within the scope of the invention,

FIG. 12 illustrates a variant of a ground modifier with a positioning arrangement which may be applied in a system within the scope of the invention,

FIG. 13 illustrates a tool point localizing module,

FIG. 14 illustrates an exemplified embodiment of a data server which may be applied within the scope of the invention to implement the invention,

FIG. 15 illustrates a surface determination module according to an embodiment of the invention,

FIG. 16 illustrates a communication between a data server and a plurality of ground modifiers working at two different terrains,

FIG. 17-a-c illustrate different stages of a modification of a terrain and how a corresponding digital representation may be modified to correspond to the actually expected performed terrain modification and where

FIG. 18 and FIGS. 18a-d illustrate a simplified version of a building site with a plurality of ground modifiers.

### DETAILED DESCRIPTION

The following section comprises a detailed description of the invention with reference to the figures.

The description comprises nonlimiting examples of embodiments of the invention. Details such as a specific method and system structures are provided to give an understanding of embodiments of the invention. Note that detailed descriptions of well-known methods, systems, devices, circuits, components including, e.g., control leads, etc. have been omitted to not obscure the description of the invention with unnecessary details. Notice that the invention is not limited to the specific examples described below, and a person skilled in the art may choose to implement the invention in other embodiments without these specific details. Furthermore, a skilled person in the field of the invention may choose to combine features of the described embodiments and of the illustrated embodiments of the invention. As such, the invention may be designed and altered in a multitude of varieties within the scope of the invention, as specified in the claims.

The invention relates to a terrain modification tracking system and to a terrain modification tracking method.

According to an embodiment of the invention, the terrain modification tracking method comprises five steps. A terrain may comprise various kinds of material, including, e.g., soil, clay, sand, gravel, vegetation, rock, asphalt, etc. Hence following, that the ground surface of the terrain may correspondingly comprise these various kinds of materials. The method may be carried out in various different ways as will be described in further details in the following sections.

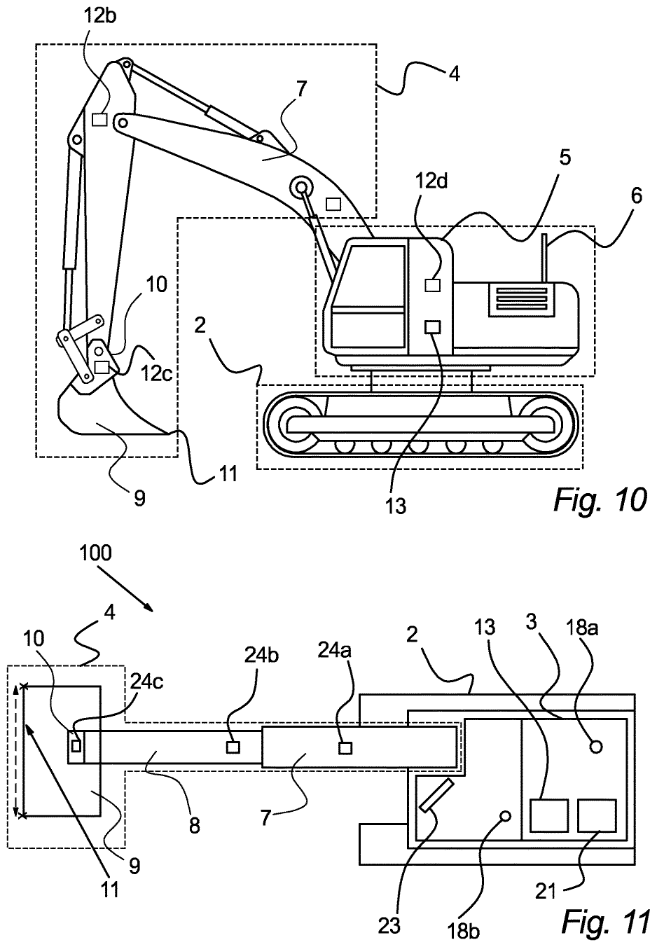

In a first method step a plurality of ground modifiers are provided. In this exemplified embodiment, the provided ground modifiers are located on a terrain of a building site. Each of the plurality of ground modifiers comprises an earthwork tool including a tool point. The ground modifiers may comprise various different types of ground modifiers, including, e.g., the ground modifiers illustrated in FIGS. 10, 11, and 12.

In a further method step a terrain comprising a ground surface is repeatedly modified using the earthwork tool of the plurality of ground modifiers, to repeatedly establish a modified terrain that comprises a modified ground surface. In this example, the modified terrain and the modified ground surface is a result of a physical modification of the terrain. The physical modification of the terrain could be carried out in many ways and using various types of earthwork tools.

In a next method step, real-time tool point position data is established for each of the plurality of ground modifiers by repeatedly tracking a tool point position of the tool point of each of the plurality of ground modifiers. By repeatedly performing the tracking of the tool point position of the tool point, the tool point position may be understood as being sampled over time, and thereby a timeseries of tool point positions is acquired for each of the plurality of ground modifiers over time. Hence the real-time tool point position data may be understood to comprise the spatial trajectory of a tool point used for modifying the terrain into a modified terrain with a modified ground surface.

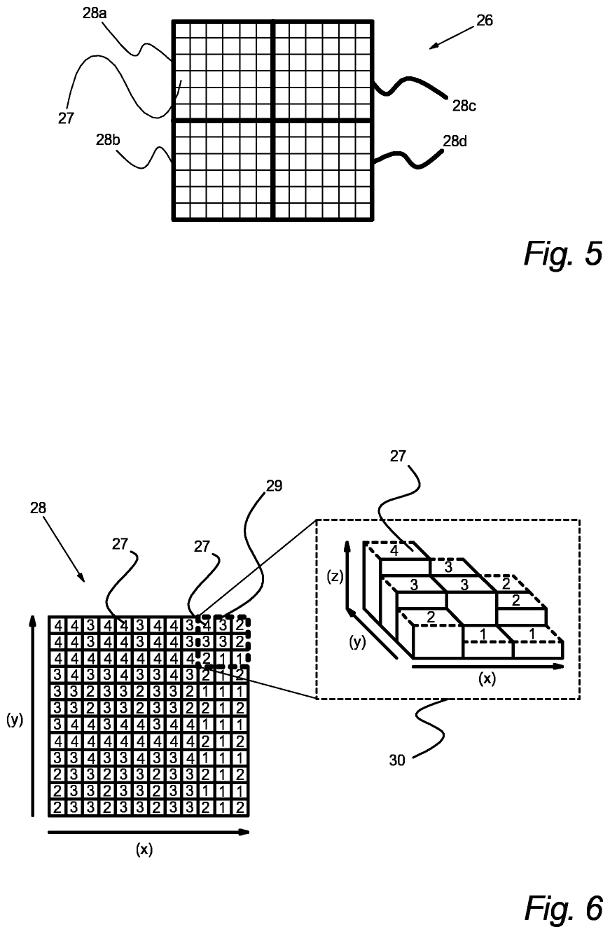

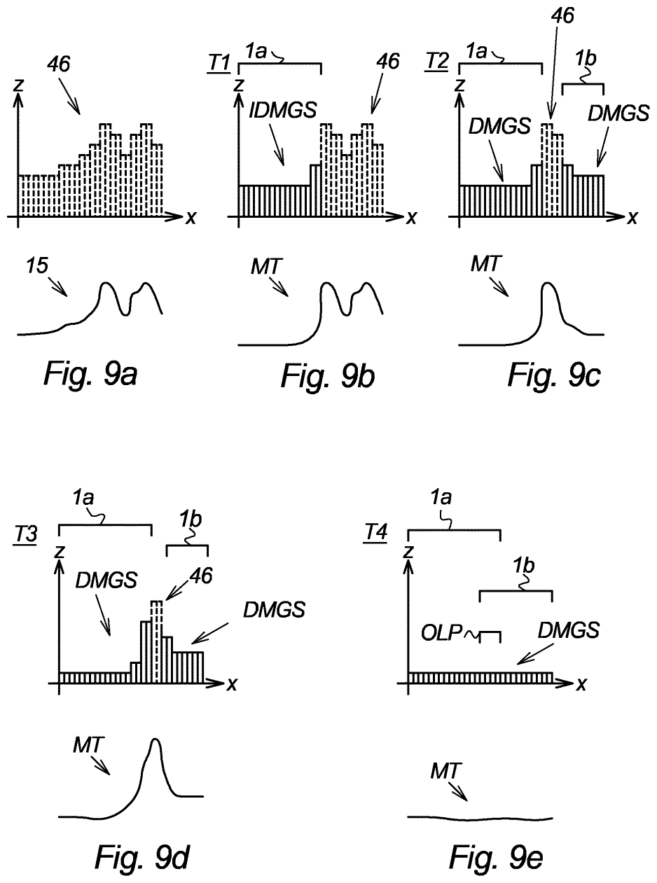

In an additional method step, a digital modified ground surface representation is repeatedly generated based on the real-time tool point position data of each of the plurality of ground modifiers. Hence, the digital modified ground surface representation may be understood as a digital representation of the modified ground surface of the modified terrain, which is generated based on the real-time tool point position data. The digital modified ground surface is repeatedly generated as the modification of the terrain and/or modified terrain is performed, and hence, the digital modified ground surface representation may therefore be understood to be substantially synchronized with the modified ground surface. Thus, the digital modified ground surface may represent a current and/or real-time state of the modified ground surface. According to the invention, the digital modified ground surface representation could be represented in many different ways, including raster representation, different kinds of vector-based representations, different analytical based representations etc. Exemplified embodiments of a digital modified ground surface representation or parts hereof and visualization of a digital modified ground surface representation is illustrated in, e.g., FIG. 5, FIG. 6, FIG. 8, FIG. 9a-e and FIG. 17a-e.

In a further method step at least a part of the digital modified ground surface representation is displayed on at least two displays, wherein at least one display of the at least two displays are associated with a ground modifiers of the plurality of ground modifiers. A display being associated with a ground modifier may be understood in a broad sense, to include, e.g., that the display is arranged as part of the ground modifier, or as a moveable display being registered to the ground modifier etc. Other displays of the plurality of displays may optionally be associated with another ground modifier of the plurality of ground modifiers. However, other displays of the plurality of displays may also not be associated with another ground modifier, but may instead be utilized by, e.g., a person such as, e.g., a project manager, who is the able to view the digital modified ground surface representation using the display. This is advantageous, in that the, e.g., a project manager may obtain an overview of the terrain modification performed by the plurality of ground modifiers via the display.

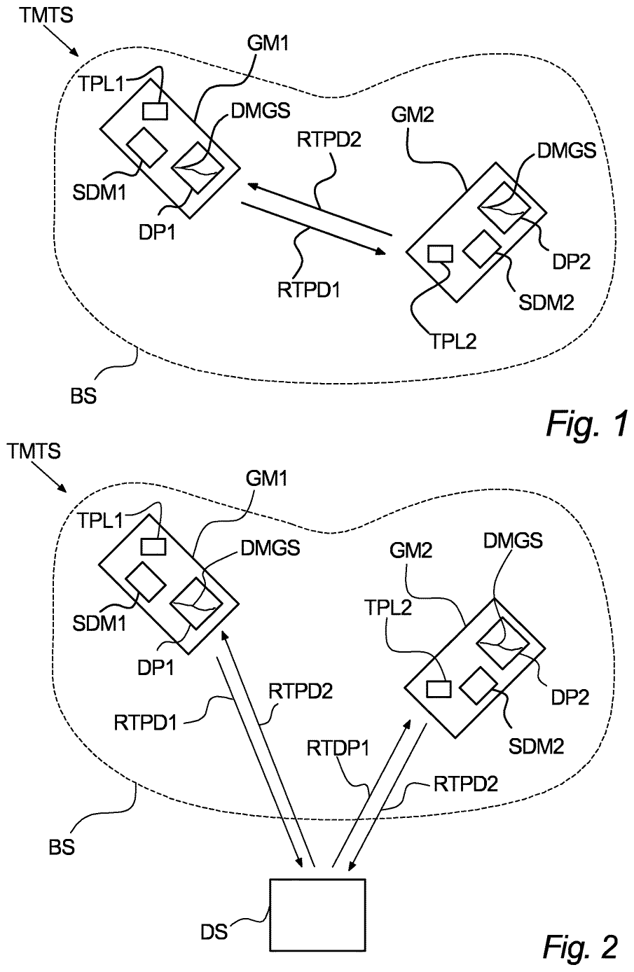

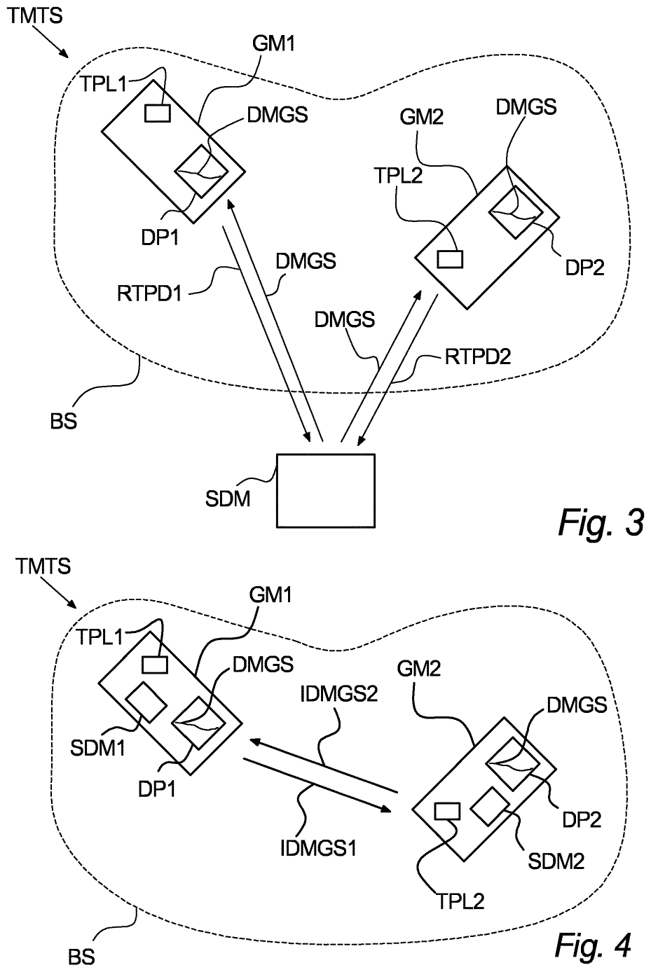

Depending on the implementation of the invention, the method steps of the above-described exemplified embodiment of the terrain modification tracking method may be performed in various different ways. E.g., the method may be performed using the terrain modification tracking system according to various embodiments of the invention, including the exemplified embodiments of terrain modification tracking systems illustrated in, e.g., FIG. 1, FIG. 2, FIG. 3 and FIG. 4.

Optionally, the at least two displays are each associated with a separate ground modifier of said plurality of ground modifiers. Advantageously, in this optional embodiment of the invention, at least two displays are each associated with a different ground modifier of the plurality of ground modifiers. E.g., one of the displays may be registered to one ground modifier and may even be fixedly arranged in that particular ground modifier, while the other display of the at least two displays may be a moveable display registered to another ground modifier of the plurality of ground modifiers. The moveable display may, e.g., be moveably mounted in the ground modifier that the display is registered to, meaning that the display may be moved out of the ground modifier if so desired.

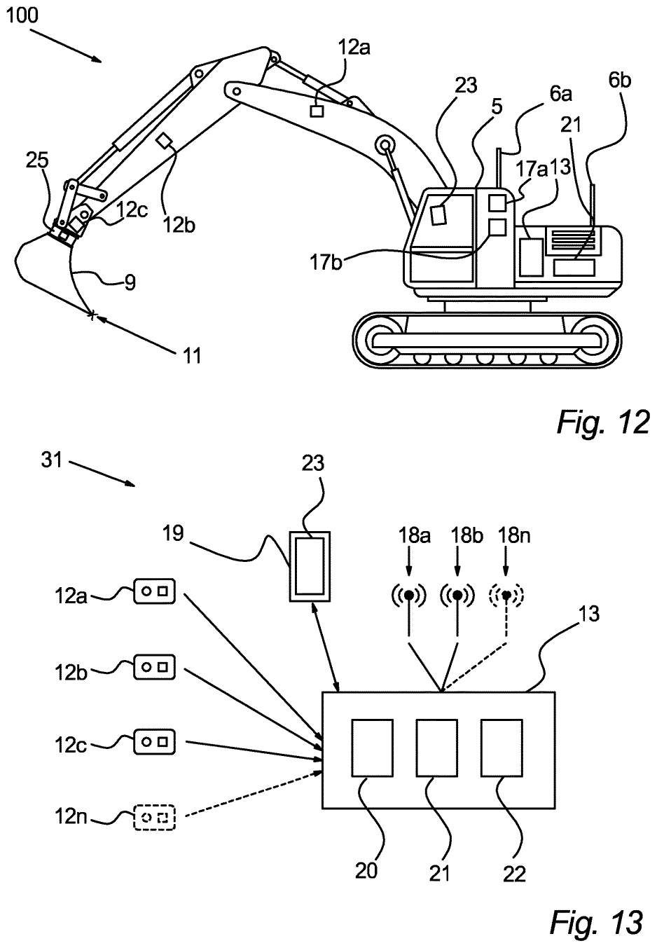

FIG. 1 illustrates a block diagram of a terrain modification tracking system TMTS utilized on a building site BS, according to an embodiment of the invention. The terrain modification tracking system TMTS comprises two ground modifiers GM1, GM2 that each comprises a tool point localizing module TPL1, TPL2, a surface determination module SDM1; SDM2 and a display DP1, DP2 displaying a part of a digital modified ground surface representation DMGSR. The two ground modifiers GM1, GM2 is configured to share real-time tool point position data RTPD1, RTPD2 with each other. Notice that the two ground modifiers could be any type of ground modifier, including, e.g., the types of ground modifiers illustrated in FIG. 10, FIG. 11 and FIG. 12. The terrain modification tracking system may be applied to perform the terrain modification tracking method according to various embodiments of the invention.

Each of the two ground modifiers GM1, GM2 is configured to utilize their respective earthwork tool to repeatedly modifying a terrain having a ground surface into a modified terrain comprising a modified ground surface. During the modification of the terrain, the tool point localizing module TPL1, TPL2 of each ground modifier repeatedly tracks the tool point of the earthwork tool of the ground modifier comprising the tool point localizing module to establish real-time tool point position data RTPD1, RTPD2. Hence, real-time tool point position data RTPD1 is repeatedly established for the first ground modifier GM1 of the two ground modifiers and for the second ground modifier GM2 of the two ground modifiers.

The surface determination module SDM1, SDM2 of each ground modifier is configured to repeatedly generate a digital modified ground surface representation DMGSR based on received tool point position data.

In this exemplified embodiment the established real-time tool point position data RTPD1 for the first ground modifier GM1 is transmitted to the second ground modifier GM2 of the two ground modifiers. Likewise, established real-time tool point position data RTPD2 for the second ground modifier is repeatedly established for the second ground modifier GM2 of the two illustrated ground modifiers GM1, GM2 and is transmitted to the first ground modifier GM1 of the two ground modifiers. The surface determination module SDM1 of the first ground modifier GM1 repeatedly receives the real-time tool point position data RTPD2 transmitted from the second ground modifier GM2 and repeatedly combines it with the real-time tool point position data RTPD1 established by the tool point localizing module TPL1 of the first ground modifier GM1 and thereby repeatedly generates combined real-time tool point position data. The combined real-time tool point position data is then utilized by the surface determination module SDM1 of the first ground modifier GM1, to repeatedly generate a digital modified ground surface representation DMGSR, which is repeatedly displayed on the display DP1 associated with the first ground modifiers GM1.

Likewise, the surface determination module SDM2 of the second ground modifier GM2 repeatedly receives the real-time tool point position data RTPD1 transmitted from the first ground modifier GM1 and repeatedly combines it with the real-time tool point position data RTPD2 established by the tool point localizing module TPL2 of the second ground modifier GM2 and thereby repeatedly generates combined real-time tool point position data. The combined real-time tool point position data is then utilized by the surface determination module SDM2 of the second ground modifier, to repeatedly generate a digital modified ground surface representation DMGSR, which is displayed on the display DP2 associated with the second ground modifier GM2.

Optionally, each ground modifier may comprise a transmitter and a receiver configured to respectively receive and transmit data such as, e.g., real-time tool point position data and/or individual digital modified ground surface representations and/or digital modified ground surface representations.

Optionally, the terrain modification tracking system may comprise a data log into which data such as digital modified ground surface representations and/or real-time tool point position data may be logged as logged data. The data log may be located in a data server. The data server may optionally be a located externally to the ground modifiers, or it may optionally be located on one ground modifier or on all ground modifiers.

Optionally, the terrain modification tracking system may be implemented to work across different building sites.

Optionally, the ground modifiers may communicate via a mesh network. Optionally, the described combining of real-time tool point position data may comprise selecting the geographical locations of overlapping real-time tool point position data that has the lowest elevation. Further optionally, the combined real-time tool point position data may be utilized to repeatedly generate a digital modified ground surface representation. Advantageously, this generates a digital modified ground surface representation that may represent the bottom of cut.

FIG. 2 illustrates a block diagram of a terrain modification tracking system TMTS with a data server DS according to an embodiment of the invention. The terrain modification tracking system is utilized on a building site BS, according to an embodiment of the invention. The terrain modification tracking system TMTS further comprises two ground modifiers GM1, GM2 that each comprises a tool point localizing module TPL1, TPL2, a surface determination module SDM1, SDM2 and a display DP1, DP2 displaying at least a part of a digital modified ground surface representation DMGSR generated by each of the two surface determination modules SDM1, SDM2. Notice that the two ground modifiers could be any type of ground modifier, including, e.g., the types of ground modifiers illustrated in FIG. 10, FIG. 11 and FIG. 12. The terrain modification tracking system may be applied to perform the terrain modification tracking method according to various embodiments of the invention.

The terrain modification tracking system TMTS illustrated in FIG. 2 functions similarly to the terrain modification tracking system illustrated in FIG. 1, except for the sharing of real-time tool point position data RRDP1, RTDP2 between the ground modifiers, which in this embodiment is performed via the data server DS. Hence, the real-time tool point position data RTPD1 established by the first ground modifier GM1 is repeatedly transmitted from the first ground modifier GM1 to the data server DS and from the data server DS to the second ground modifier GM2. Likewise, the real-time tool point position data RTPD2 from the second ground modifier GM2 is repeatedly transmitted from the second ground modifier GM2 to the data server DS and from the data server DS to the first ground modifier GM1.

As with the embodiment illustrated in FIG. 1, digital modified ground surface representations are repeatedly generated on the surface determination module SDM1, SDM2 on each machine and displayed on a display DM1 associated with the first ground modifier GM1 and on a display DP2 associated with the second ground modifier GM2.

Optionally, one of the displays DP1, DP2 may not be associated with any of the two ground modifiers. Thus, at least one of the displays may optionally be a display viewable to a person not necessarily operating a ground modifier. Such person could, e.g., be a project manager, requiring an overview of a building site at which, e.g., ground modifiers operate. By having at least one display not associated with a ground modifier, the display may be utilized to obtain an overview of the progress of the ground modification performed by ground modifiers, which is advantageous.

In the illustrated example of the terrain modification tracking system, the data server is located outside of the illustrated building site BS, however, it could also be located on the building site.

Optionally, the real-time tool point position data is transmitted to and from the server via the internet.

Optionally the data server may be a cloud server.

Optionally, the data server may comprise a data log, configured to log data, including digital modified ground surface and/or real-time tool point position data.

Optionally, the data log comprising logged data may be accessed by one or more computing devices, which may generate digital modified ground surface representations based on the logged data and/or manipulate the logged data.

FIG. 3 illustrates a block diagram of a terrain modification tracking system TMTS with an external surface determination module SDM, according to an embodiment of the invention. The terrain modification tracking system TMTS is utilized on a building site BS, according to an embodiment of the invention. The terrain modification tracking system TMTS further comprises two ground modifiers GM1, GM2 that each comprises a tool point localizing module TPL1, TPL2 and a display DP1, DP2 displaying at least a part of a digital modified ground surface representation DMGSR. Notice that the two ground modifiers could be any type of ground modifier, including, e.g., the types of ground modifiers illustrated in FIG. 10, FIG. 11 and FIG. 12. The terrain modification tracking system may be applied to perform the terrain modification tracking method according to various embodiments of the invention.

Contrary to the terrain modification tracking systems illustrated in FIG. 1 and FIG. 2, the system illustrated in FIG. 3 comprises a surface determination module SDM located external with respect to the two ground modifiers. Furthermore, the two ground modifiers GM1, GM2 does not comprise a surface determination module. Hence, in this exemplified terrain modification system TMTS, each of the ground modifiers GM1, GM2 establishes real-time tool point position data RTPD1, RTPD2 using their own tool point localizing module TPL1, TPL2. The real-time tool point position data RTPD1, RTPD2 repeatedly established by each ground modifier GM1, GM2 is then repeatedly transmitted to the surface determination module SDM. The surface determination module SDM then repeatedly generates a digital modified ground surface representation based on the received real-time tool point position data RTPD1, RTPD2 from each of the ground modifiers GM1, GM2 and repeatedly transmits the digital modified ground surface representation back to each of the two ground modifiers GM1, GM2. The digital modified ground surface representation DMGSR is then displayed on each display DP1, DP2. In this embodiment the first display DP1 is associated with the first ground modifier GM1, whereas the second display DP2 is associated with the second ground modifier GM2.

In this embodiment the surface determination module is located outside of the building site BS. However, it is within the scope of the invention to provide a surface determination within a building site.

Optionally, the surface determination module may be included as part of a data server.

Notice that irrespective of which embodiment of the terrain modification tracking system that is implemented, the data of local positioning sensors and global positioning sensors may also be shared among ground modifiers and/or one or more data servers, and be utilized to generate digital modified ground surfacer representations. E.g., each ground modifier may transmit the mentioned sensor data to a data server comprising a tool point localizing module and a surface determination module. The data server is thereby capable of establishing real time tool point position data using the tool point localizing module, and further capable of repeatedly generating a digital modified surface representation based on the established real-time tool point position data. The data server may then repeatedly transmit the generated digital modified ground surface representation back to the ground modifiers and/or potentially other relevant machines or computing units. The ground modifiers and the other relevant units may then display the whole digital modified ground surface representation and/or at least a part of the digital modified ground surface representation on displays. Thereby, each of the ground modifiers may not necessarily need a tool localizing module and a surface determination module, which is advantageous.

FIG. 4 illustrates a block diagram of a terrain modification tracking system TMTS utilized on a building site BS, according to an embodiment of the invention. The terrain modification tracking system TMTS comprises two ground modifiers GM1, GM2 that each comprises a tool point localizing module TPL1, TPL2, a surface determination module SDM1; SDM2 and a display DP1, DP2 displaying a part of a digital modified ground surface representation DMGSR. The system is similar to the system illustrated in FIG. 1, except that in the system illustrated in FIG. 4, the two ground modifiers GM1, GM2 is configured to share individual digital modified ground surface representations rather than real-time tool point position data RTPD1, RTPD2 with each other. Notice that the two ground modifiers could be any type of ground modifier, including, e.g., the types of ground modifiers illustrated in FIG. 10, FIG. 11 and FIG. 12. The terrain modification tracking system may be applied to perform the terrain modification tracking method according to various embodiments of the invention.

Each of the two ground modifiers GM1, GM2 is configured to utilize their respective earthwork tool to repeatedly modifying a terrain having a ground surface into a modified terrain comprising a modified ground surface. During the modification of the terrain, the tool point localizing module TPL1, TPL2 of each ground modifier repeatedly tracks the tool point of the earthwork tool of the ground modifier comprising the tool point localizing module to establish real-time tool point position data RTPD1, RTPD2. Hence, real-time tool point position data RTPD1 is repeatedly established for the first ground modifier GM1 of the two ground modifiers and for the second ground modifier GM2 of the two ground modifiers. The surface determination module SDM1, SDM2 of each ground modifier is configured to first repeatedly generate individual digital modified ground surface representation IDMGS1, IDMGS2 based on established tool point position data and to repeatedly generate a digital modified ground surface representation based on both the individual digital modified ground surface representation of the another ground modifier and further based on the individual digital modified ground surface representation generated by the tool point localizing module of the ground modifier. Hence the individual digital modified ground surface representation of one ground modifier, e.g., the first ground modifier GM1 represents ground modifications performed by that first ground modifier GM1, and likewise the individual digital modified ground surface representation of another ground modifier, e.g., the second ground modifier GM2 represents ground modifications performed by that second ground modifier GM2. The digital modified ground surface representation DMGSR is generated based on the two individual digital modified ground surface representation IDMGS1, IDMGS2 and thus represents ground modifications performed by both ground modifiers, e.g., the modified ground surface established by the work performed by both ground modifiers.

In this exemplified embodiment the established individual digital modified ground surface representation IDMGS1 for the first ground modifier GM1 is transmitted to the second ground modifier GM2 of the two ground modifiers. Likewise, established individual digital modified ground surface representation IDMGS2 for the second ground modifier GM2 is repeatedly established for the second ground modifier GM2 of the two illustrated ground modifiers GM1, GM2 and is transmitted to the first ground modifier GM1 of the two ground modifiers. The surface determination module SDM1 of the first ground modifier GM1 repeatedly receives the individual digital modified ground surface representation IDMGS2 transmitted from the second ground modifier GM2 and repeatedly combines it with the individual digital modified ground surface representation established by the surface determination module SDM1 of the first ground modifier GM1 and thereby repeatedly generates a digital modified ground surface representation. The repeatedly generated digital modified ground surface representation DMGS is repeatedly displayed on the display DP1 associated with the first ground modifiers GM1.

Likewise, the surface determination module SDM2 of the second ground modifier GM2 repeatedly receives the individual digital modified ground surface representation transmitted from the first ground modifier GM1 and repeatedly combines it with the individual digital modified ground surface representation established by the surface determination module SDM2 of the second ground modifier GM2 and thereby repeatedly generates a digital modified ground surface representation. The digital modified ground surface representation corresponds to the digital modified ground surface representation generated by the surface determination module SDM1 of the first ground modifier GM1. The repeatedly generated digital modified ground surface representation DMGS, is then repeatedly displayed on the display DP2 associated with the second ground modifier GM2.

The generation of the digital modified ground surface representation based on individual digital modified ground surface representation may be utilized in other embodied terrain modification tracking systems. E.g., individual digital modified ground surface representations may be shared via a data server similar to the sharing of real-time tool point positions as exemplified in FIG. 2.

Advantageously, by generating individual digital modified ground surface representation on each ground modifier, the ground modifier may display these representations in case data such as real-time tool point position data or individual digital modified ground surface representation is not received from other relevant ground modifiers. This could, e.g., occur due to a communication breakdown.

Optionally, the described combining individual digital modified ground surface representations into a digital modified ground surface representation may comprise selecting the geographical locations of the two individual digital modified ground surface representations that are overlapping, and in these overlapping geographical locations, select the geographical location that has the lowest elevation. Advantageously, this repeatedly generates a digital modified ground surface representation that may represent the bottom of cut of the modified ground surface.

FIG. 5 illustrates an example of a schematical two-dimensional view of a digital modified ground surface representation according to the invention. Notice, however, that digital modified ground surfaces and individual digital modified ground surfaces may be represented in the same way according to the invention. The difference being that in the context of the invention, the digital modified ground surface representation represents a modified ground surface modified based on work performed by two or more ground modifiers, whereas the individual digital modified ground surface representation represents a modified terrain or part of the modified terrain that has been modified by only a single ground modifier. Hence, the principles described in relation to FIG. 5 and FIG. 6 applies to both digital modified ground surface representations and to individual digital modified ground surface representations, and even to digital ground surface representations.

The digital modified ground surface representation is a representation of a modified ground surface. The illustrated digital modified ground surface 26 comprises 144 grid points 27, which in this example is subdivided into four grid tiles 28a,28b,28c,28d, each comprising 36 grid points. This subdivision into grid tiles may not necessarily be implemented for all digital modified ground surface representations or the grid tiles may be implemented differently. The digital modified ground surface representation may expand to include further grid points as the ground modifier moves around the tool point. Other digital modified ground surface representations may thereby be larger or smaller and comprise fewer or more grid tiles and grid points. A grid point may, e.g., be understood as a representation of a cell having dimensions, e.g., a size. The dimension of the grid tile may be varied to be larger or smaller than the exemplified grid size of this embodiment. Hence, each grid point may represent information of a modified ground surface. E.g., a grid point may represent an area of a modified ground surface. Each grid tile 28 represents a portion, such as an area of a modified ground surface of a terrain. In this example, each grid point has a grid size representing 0.01 square meter, meaning that each grid point represents 0.01 square meter of a modified ground surface. The dimensions (sometimes referred to as a size) of the individual grid tiles 28a-d represent a larger area of a terrain compared to the grid points 27. In this example, each grid tile represents 0.36 square meter, which corresponds to 36 grid points. However, in other implementations of the invention, the dimensions of the grid tiles may be smaller or larger. A digital modified ground surface representation may have fewer or more grid points than what is exemplified in this embodiment. The grid size may be varied, and the amount of grid points per grid tile may also be varied to be larger or smaller than what is exemplified in this exemplified embodiment of the invention.

In some optional embodiments of the invention, a digital modified ground surface may be updated per grid tile, even if said digital modified ground surface is larger than a grid tile. This may sometimes also be referred to as tile wise update. This has the advantage that the full digital surface representation does not need to be updated at once, which may reduce data transfer and processor demands required for updating the digital modified ground surface. The dimension of a grid tile may vary depending on the implementation of the invention. Thus, a grid tile may, e.g., in another exemplified embodiment have a size of 144 square meters. Similarly, the size of the grid points may vary across different implementations of the invention. A small grid size may provide a more accurate representation of a modified ground surface, however, this comes at the expense of requiring more time to compute and requiring larger data transfer and storage due to the increased data size of a digital modified ground surface representation with a higher resolution (or correspondingly smaller grid point size).

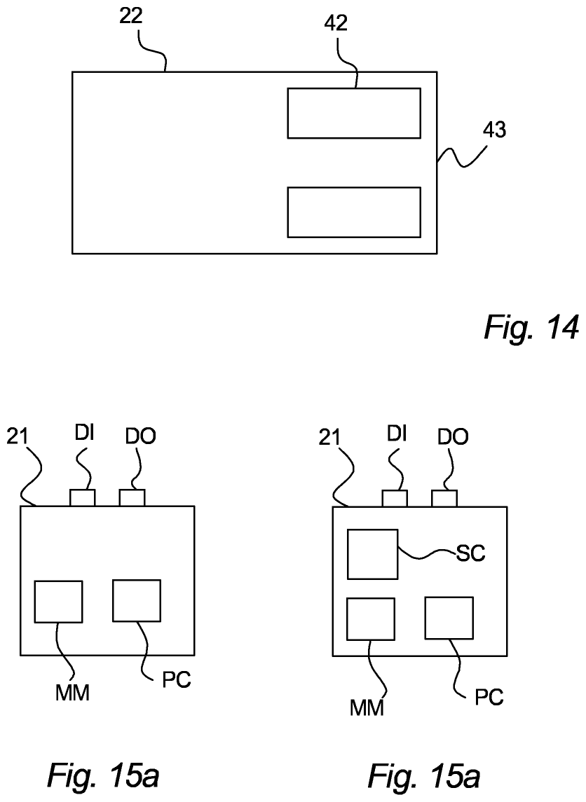

The digital modified ground surface representation may optionally be stored on a data server such as the data server illustrated in, e.g., FIG. 14. However, the digital modified ground surface representation may also be stored on a ground modifier comprising a data storage. Such a ground modifier could, e.g., include any of the ground modifiers illustrated in FIG. 10, FIG. 11 and FIG. 12, if these ground modifiers where implemented with a data storage.

Each grid point may be indexed. The index may be unique to that grid point, such that only one grid point of a modified digital ground surface has that index. The digital modified ground surface representation may be updated during the modification of a terrain, as the modified ground surface changes, and the updated digital modified ground surface representation may be stored. Various types of storing may be utilized in different implementations of the invention. The storing may be performed by storing a digital modified surface representation. E.g. by an absolute storing of all grid tiles of the digital modified surface representation. Also, the storing may be performed per grid tile. Hence, grid tiles may be updated and stored individually. This may be advantageous, in that only grid tiles that has been changed are stored. Other grid tiles that has not change may thus not need to be stored. A time stamp indicating a time of storage may be registered to stored grid tiles. A stored digital modified ground surfaces may also sometimes be referred to as a logged digital modified ground surface representation. In the present context, logging may thus sometimes be referred to as storing.

Storing (logging) may, also, e.g., be performed based on differential logging, in which only the differences in the digital modified ground surface representation since the last storing/transmitting of a digital modified ground surface representation has been performed. This may, advantageously, reduce storage requirement and the amount of data transfer. Differential logging may optionally be performed per grid tile as described above in relation to the absolute storing.

In an embodiment of the invention, the digital modified ground surface representation may optionally be stored as a raster image (also referred to as a bitmap). E.g., it may, optionally, be stored as a png file or using other image formats and/or file formats. The raster image (sometimes referred to as raster data) may be considered a rectangular matrix of cells (grid points), which may, e.g., be represented in rows and columns. Each grid point (cell) may represent a defined area on the earth's surface and holds a value that is the same across the entire grid point. This may sometimes be referred to as a zero order approximation. Hence, a digital modified ground surface representation may be stored as a raster image, where each grid point in the raster image represents some value of real-world information, e.g., related to the digital modified ground surface representation. Each grid point may comprise various types of data, including e.g. elevation data. Notice that in FIG. 5, the grid is illustrated in two dimensions, and hence, elevation data is not illustrated. Optionally, various types of metadata may also be stored with the digital modified ground surface representation. Optionally, metadata relating to specific grid points may be stored together with other data relating to that grid point, such as, e.g., a tag representing a ground modifier that performed ground modification in of the real world area represented by the grid point, ground material type, ground fill type, ground modifier ID, time stamp data, GNSS quality, color, number of passages of, e.g., a ground modifier or a tool point, etc.

Optionally, the illustrated digital modified ground surface representation may be visualized in a multitude of ways including 2D and/or 3D representations on a display, e.g., including the exemplified display associated with any one of the ground modifiers illustrated in FIG. 10, FIG. 11 and FIG. 12.

Surfaces such as a ground surface and/or a modified ground surface and/or an updated modified ground surface may be digitally represented in various ways, according to the invention. In principle, a surface of a terrain may comprise an infinite number of points, and since it may not be possible to represent a surface by an infinite number of samples, a digital representation of a surface of a terrain (also referred to as a digital ground surface representation and/or if the terrain has been modified, referred to as a modified digital ground surface representation or an individual digital modified ground surface representation) approximates the surface of the terrain based on surface samples representing the surface, e.g., the elevation of the surface, at different positions of the surface.

Optionally, the surface grid points may be interpolated to obtain the values between these sampled points. First order, second order, third order or higher approximations and/or other approximations may be applied according to various embodiments of the invention.

FIG. 6 illustrates an example of another grid tile different to the four grid tiles illustrated in FIG. 5. The grid tile illustrated in FIG. 6 comprises elevation data and further illustrates a three-dimensional representation of a grid point section of the grid tile according to an embodiment of the invention. The grid tile represents a grid tile of a digital modified ground surface representation. Again, notice that digital modified ground surfaces and individual digital modified ground surfaces may be represented in the same way according to the invention. The difference being that in the context of the invention, the digital modified ground surface representation represents a modified ground surface modified based on work performed by two or more ground modifiers, whereas the individual digital modified ground surface representation represents a modified terrain or part of the modified terrain that has been modified by only a single ground modifier. Hence, the principles described in relation to FIG. 5 and FIG. 6 applies to both digital modified ground surface representations and to individual digital modified ground surface representations, and even to digital ground surface representations.

The exemplified grid tile 28 of FIG. 6 now comprises a plurality (12×12=144) of grid points 27. In this exemplified embodiment of the invention, the grid points are indexed based on a set of two coordinates, which is illustrated with an x and a y. The coordinates indicate a position within the digital modified ground surface representation. This position further corresponds to a global position, also referred to as a geographical location. Notice that the invention may be implemented using a different indexing.

The x coordinate indicates the column of the grid tile, while the y coordinate indicates the row of the grid. Furthermore, each grid point (the third dimension) comprises a value. In this embodiment the value corresponds to elevation data, which indicates an elevation of a tool point position of a ground modifier. In this particular embodiment, the tool point position comprises the coordinates x and y, and the elevation value z. Thus, the grid tile comprises grid points that all represent different tool point positions established during a modification of a ground surface of a terrain. The tool point being represented by the three coordinates x, y, z. Where the x, y coordinates defines a geographical location and the z coordinate define the elevation at the geographical location. The grid point section 29 comprises nine grid points comprising values between 1 and 4. As mentioned, the values represent an elevation of a tool point position (this is describes as real-time tool point positions when the tool point position is tracked or sampled), whereas their coordinates represent the other two dimensions of the tool point position. By visualizing the digital modified ground surface representation in three dimensions it may be possible to achieve a visual representation of a modified ground surface of a terrain. This may be realized by viewing the three dimensional grid point section representation 30 of the grid point section 29, which may be considered a subset of a digital modified ground surface representation.

Optionally, a tool point position may be represented as geodetic coordinates.

Optionally, the digital modified ground surface is only updated when position information of a tool point comprises an elevation that is lower compared to an elevation at the corresponding position of the current digital modified ground surface representation. E.g., if the tool point at a global position, e.g. defined by coordinates x, y has an elevation of 4 and the corresponding elevation at that same geographical location in the digital modified ground surface representation is 7, then the digital modified ground surface representation is updated with the elevation of 4 of the tool point at that geographical location. On the contrary, as an example, the digital modified ground surface representation may not be updated if the elevation of the tool point at the particular geographical location had an elevation larger than the elevation of the digital modified ground surface representation at the same geographical location. In this case, the digital modified ground surface representation may thus not be updated if the elevation of the tool point is 7 or more.

Optionally, the digital modified ground surface representation is only updated when the position information of a tool point at a geographical location comprises an elevation that is lower than an elevation at a corresponding geographical location of the digital ground surface representation.

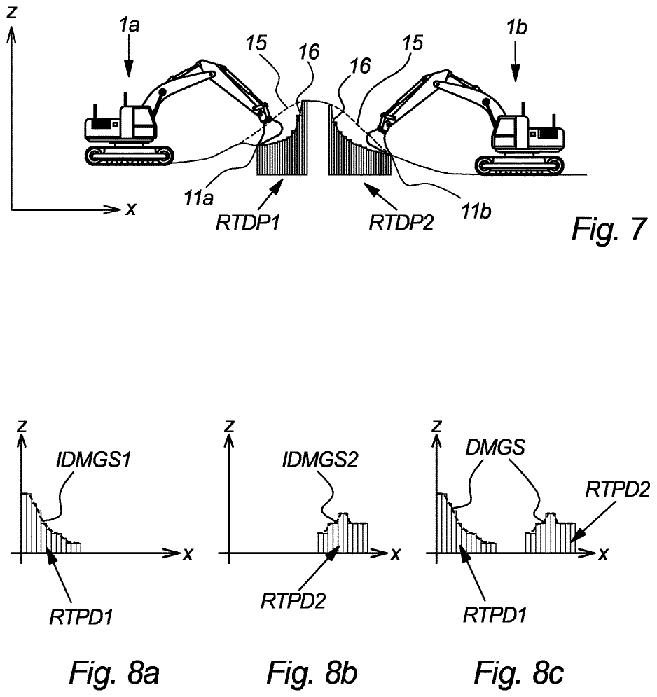

FIG. 7 illustrates establishing of real-time tool point position data during ground modification using two ground modifiers 1a, 1b, according to an embodiment of the invention. The two ground modifiers 1a, 1b could be any type of ground modifier, including, e.g., the ground modifiers illustrated in FIG. 10, FIG. 11 and FIG. 12.

As illustrated, a first ground modifier la and a second ground modifier 1b is provided on a terrain having a ground surface 15. The two ground modifiers 1a, 1b have been performing a ground modification to establish a modified terrain having a modified ground surface 16. In this exemplified embodiment, the two ground modifiers have been modifying the terrain by digging. During the digging, the tool point of each ground modifier has been tracked repeatedly and thereby real-time tool point position data RTDP1, RTDP2 has repeatedly been established for each of the two ground modifiers 1a, 1b. The real time tool point position data established during the time course of the ground modification is illustrated as two dimensional data represented by a z-direction and an x-direction. Notice, however that the real-time tool point position data is actually tracked as three dimensional data comprising elevation, and a geographical location, as described elsewhere in this disclosure. In FIG. 7, the coordinate z represents an elevation of the real-time tool point position data and the x coordinate represents one dimensions of a geographical location of the real time tool point position data RTPD1, RTPD2.

The first ground modifier has been performing a digging motion that has resulted in a modified ground surface following an exponential-like shape. It may be appreciated that the tracked real time tool point position data RTDP1 representing the tool point positions of the tool point of the first ground modifier relatively closely follows the same exponential-like shape in the illustrated the x-z plane. The second ground modifier 1b has performed a similar digging motion to modify the ground surface 15 of the terrain into a modified terrain with a modified ground surface 16. During the ground modification made by the second ground modifier using its earthwork tool having a tool point, the tool point has been tracked, resulting in the illustrated real-time tool point position data RTDP2, associated with the second ground modifier 1b. Notice how the real-time tool point position data represents the modified ground surface in the x-y plane.

Digital modified ground surface representations that represents the modified ground surface 16 established by the modifications of the terrain performed by both the first and the second ground modifier 1a, 1b may be generated and displayed on a plurality of displays repeatedly during the performed ground modification based on the repeatedly established real-time tool point position data RTPD1, RTPD2 of the two ground modifiers 1a, 1b m, according to various embodiments of the invention, including, e.g., embodiments of the terrain modification tracking systems illustrated in FIG. 1, FIG. 2, FIG. 3 and FIG. 4, and further based on the terrain modification tracking method according to various embodiments of the invention.

Notice that a modification of a terrain may comprise removing material from the terrain, often resulting in a modified terrain having a lower elevation compared to the original terrain before it was modified. The ground modification process often requires performing ground modification at the same geographical location a plurality of times and even more than one ground modifier may perform ground modification on a geographical location whereat another ground modifier has also performed ground modification. When a ground surface and/or modified ground surface is modified more than once by a ground modifier, optionally, the established real-time tool point position having the lowest elevation at that geographical location is selected and used for generation of the digital modified ground surface representation and/or for the individual digital modified ground surface representation. Advantageously, this may have the effect that the digital modified ground surface representation and/or the individual digital modified ground surface representation represents the bottom of cut (the deepest). By always representing the deepest elevation across all geographical locations at which ground modification has been performed, displayed and/or logged digital modified ground surface representation and/or digital modified ground surface representation may, advantageously, always represent the bottom of cut.

FIG. 8a, FIG. 8b and FIG. 8c together illustrates combining individual digital modified ground surface representations into a digital modified ground surface representation according to various embodiments of the invention.

FIG. 8a illustrates the relationship between real-time tool point position data RTPD1 established by a first ground modifier, and the corresponding individual digital modified ground surface representation IDMGS1 generated based on these real-time tool point position data. The representation of the individual digital modified ground surface representation and the real-time tool point position data is illustrated in a simple manner in only the two-dimensions z and x, where z represents elevation data and x represents one dimension of the geographical location. Geographical location is actually described in two dimensions and, e.g., based on geodetic coordinates. As illustrated, the individual digital modified ground surface representation closely mimics the elevation data and the location of the real-time tool point position data. In some embodiments of the invention, the individual digital modified ground surface representation, optionally, may be an actual rendering of the real-time tool point position data comprising an elevation at each sampled geographical locations. In this embodiment of the invention an interpolation has been applied to the individual digital modified ground surface representation IDMGS1.

Similar to FIG. 8a, FIG. 8b illustrates the same relationship between real-time tool point position data RTDP2 and an individual digital modified ground surface representation IDMGS2. However in FIG. 8b the illustration relates to real-time tool point data RTDP2 established by a second ground modifier. Notice that both the real-time tool point position data and the individual digital modified ground surface representation illustrates that the second ground modifier has been modifying a terrain at a different location represented by the x axis, compared to the first ground modifier.

FIG. 8c illustrates a digital modified ground surface representation established based on data from both of the first ground modifier and the second ground modifier. FIG. 8c thus illustrates the real-time tool point position data that the digital modified ground surface representation DMGS is generated on the basis of. Notice that the digital modified ground surface representation DMGS only comprises data at locations (x dimension) at which either the first or the second ground modifier has been establishing real-time tool point position data. In some embodiments of the invention, the digital modified ground surface representation, optionally, may be an actual rendering of real-time tool point position data. However, in this exemplified embodiment of the invention, an interpolation has been applied to the digital modified ground surface representation DMGS to create a digital modified ground surface representation that visually resembles a surface more closely. It should be understood that interpolating the digital modified ground surface is an optional feature of the invention.

Optionally, individual digital modified ground surface representations and/or digital modified ground surface representations may be preprocessed before it is displayed on a display. Optionally, the preprocessing may comprise, e.g., smoothing, interpolation, and various types of filtering.

Notice that the individual digital modified ground surface representations IDGMS1, IDMGS2 and the digital modified ground surface representation DMGS, may be generated in different ways based on elevation data and corresponding geographical location data, including based on real-time tool point position data, according to various embodiments of the invention, and including combinations of these embodiments. E.g., digital modified ground surface representations may be generated based on embodiments of the terrain modification tracking method and based on embodiments of the terrain modification tracking system, including, e.g., the embodiments hereof illustrated in FIG. 1, FIG. 2, FIG. 3, and FIG. 4. Further notice that the mentioned first and second ground modifiers may be ground modifiers of various types, including the ground modifiers illustrated in FIG. 10, FIG. 11 and FIG. 12.

FIG. 9a-9e illustrates snapshots at times T1-T4 of digital modified ground surface representations DMGSR and an individual digital modified ground surface representation IDMGS, generated at different times during a ground modification performed by a first ground modifier la and a second modifier 1b, respectively, along with corresponding snapshots of the associated modified terrains MT. A digital ground surface representation DGS representing the ground surface 15 of the terrain before it is modified by the ground modifiers is also illustrated at time T0. Notice that providing a digital ground surface representation is an optional feature of the invention. The digital modified ground surface representations and individual digital modified ground surface representation may be generated according to various embodiments of the invention and using various ground modifiers according to different embodiments of the invention.

Notice that the times T0-T4 represents snapshots (timepoints) of a chronological timeseries staring at T0 and ending at T4. During the timeseries, a terrain 15 is modified to establish a modified terrain MT at T1. At T2 the modified terrain has been further modified and at time T3 the terrain has been even further modified and at time T4, the modified terrain has been modified into a finalized modified terrain. The modified terrain is digitally represented at each time point as digital modified ground surface representation DMGS and individual digital modified ground surface representation IDMGS.

FIG. 9a illustrates a digital ground surface representation of a ground surface of the illustrated modified terrain 15. The digital ground surface representation may be obtained in various ways. This may include, e.g., based on a drone scan of the ground surface providing elevation and geographical location data, by tracking the elevation based on a ground modifier having an onboard GNSS system and optionally other elevation sensors, which enables tracking of the elevation of the terrain and associating the tracked elevation with geographical location.

FIG. 9b illustrates at Time T1 a modified terrain MT and an associated individual digital modified ground surface representation IDMGS representing the modified ground surface of the modified terrain established by the first ground modifier at time T0. Notice that the illustrated ground surface representation 46 represents the parts of the modified terrain that has not yet been modified. Generation and displaying of the ground surface representation may be considered an optional feature of the invention. At this timepoint T1, only the first ground modifier la has been modifying the terrain 15 into the modified terrain MT.

FIG. 9c illustrates a modified terrain MT and a corresponding digital modified ground surface representation DMGS at a third timepoint T2. At this timepoint, the first ground modifier 1a has continued its ground modification work from timepoint T1 as represented by the part of the digital modified ground surface representation DMGS. The added work performed by the first ground modifier la may be realized by observing the part of the digital modified ground surface representation DMGS marked with the bracket ‘1a’, as this part represents ground modification established by the first ground modifier 1a. Notice how the bracket 1a has extended from timepoint T1 to timepoint T2. Also from timepoint T1 to timepoint T2 a second ground modifier has performed ground modification at a locations different to the locations at which the first ground modifier has been modifying the modified ground surface. The work performed by the second ground modifier is marked in the digital modified ground surface representation DMGS with the bracket 1b. Hence, at this timepoint there is no overlap between the ground modification work performed by the two ground modifiers.

FIG. 9d illustrates a further modified terrain MT and a corresponding digital modified ground surface representation at a fourth timepoint T3. At this timepoint the digital modified ground surface representation DMGS is expanded to represent the additional work performed by the two ground modifiers from the timepoint T3 to the timepoint T4. In other words, the digital modified ground surface representation DMGS at timepoint T4 represents the modified ground surface at T4. Notice that there is not overlap between the work performed by the two ground modifiers.

FIG. 9e illustrates a further modified terrain MT and a corresponding digital modified ground surface representation at a fifth timepoint T4. At this timepoint the digital modified ground surface representation DMGS is further expanded from timepoint T3 to represent modified ground surface at timepoint T4. Notice that from timepoint T3 to timepoint T4, the second ground modifier has been performing ground modification at geographical locations whereat the first ground modifier had previously been modifying the terrain. The part of the digital modified ground surface representation that represents this overlapping work is highlighted by the bracket OLP illustrating the overlapping region. In the overlapping region, the second ground modifier has been modifying the ground so that the modified ground surface at T4 has a lower elevation in the overlapping region (or correspondingly in the overlapping geographical locations) compared to the elevation in this region at timepoint T3. To generate a digital modified ground surface representation that represents the actual bottom of cut of the modified terrain MT, the elevation comprised by the real-time tool point positions for each geographical location of the overlapping region is compared between the two ground modifiers, and for each of the overlapping geographical locations, the lowest elevation is selected and these real-time tool point position data is then utilized to generate the digital modified ground surface representation.

In FIGS. 9b-9e, the digital modified ground surface representations have been illustrated in two dimensions. In principle, the digital modified ground surface representation could also be displayed on a display according to the invention in two dimensions, as illustrated in these figures. However in a preferred embodiment of the invention, the digital modified ground surface representation may be displayed in three dimensions (in 3D).

Furthermore, the timepoint should be understood as exemplified timepoints and not as representing an actual update frequency with which digital modified ground surface representations are generated, updated and/or displayed.

In preferred embodiments of the invention, the digital modified ground surface representation may preferably be generated and displayed repeatedly during the ground modification with an update frequency that is fast compared to the ground modification performed by ground modifiers. Thereby, operators viewing a displayed digital modified ground surface representation may have the perception that the digital modified ground surface representation is updated in real-time and substantially synchronously with the performed ground modification that the generated and displayed digital modified ground surface representation represents.

Optionally, the digital modified ground surface representations is only generated based on position information with elevation that is lower than the ground surface, wherein the ground surface may be represented by a digital ground surface representation.

Optionally, the digital modified ground surface representations is only generated based on position information with elevation that is lower than the ground surface, wherein the ground surface may be represented by a digital ground surface representation.

Optionally, the digital modified ground surface representations is only generated based on real-time tool point position data having an elevation that is lower than the ground surface, wherein the ground surface may be represented by a digital ground surface representation.

Optionally, the tool point position is only tracked based on real-time tool point position data having an elevation that is lower than the ground surface at a corresponding geographical location.

FIG. 10 illustrates a schematical side view of a ground modifier with a positioning arrangement, according to an embodiment of the invention. The positioning arrangement comprises a local positioning arrangement and a global positioning arrangement. The ground modifier may be utilized as part of a ground modification system according to various embodiments of the invention, together with one or more other ground modifier(s). The ground modifier may further be utilized to perform the terrain modification tracking method according to various embodiments of the invention, together with one or more other ground modifier(s). The one or more other ground modifiers may, e.g., include the ground modifiers described in relation to FIG. 11 and FIG. 12.

The ground modifier comprises a wheelbase 2 carrying a body portion 3 to which a ground modification arrangement 4 is mounted. The ground modifier further comprises a tool point localizing module 13.

The wheelbase 2 of the ground modifier is configured to enable the ground modifier to move horizontally with respect to the surface of the terrain on which the ground modifier is positioned (provided), e.g., a ground surface or a modified ground surface. The wheelbase 2 may be configured in various ways and hence, the wheelbase 2 may comprise a plurality of wheels and/or crawlers (tracks) with rollers and/or belts, etc., or combinations thereof.

In this embodiment, the body portion 3 of the ground modifier 1 is a rotation body, which comprises a motor (not illustrated), a cab 5, and a global positioning arrangement 6. Thereby, the body may rotate at least 360 degrees with respect to the wheelbase. The global positioning arrangement 6 is configured to provide global position information of the ground modifier 1. In this exemplified embodiment, the global positioning arrangement is a global navigation satellite system (GNSS) receiver. The global positioning information provided by the GNSS receiver provides information of the position of the ground modifier by way of GNSS coordinates. In this embodiment, the global positioning arrangement 6 is positioned on the body portion 3, however, in other optional embodiments, it may be arranged differently and on other positions of the ground modifier 1.

The ground modification arrangement 4 is fixated to the body portion 3 of the ground modifier. The ground modification arrangement 4 comprises standard excavator components including a boom 7 moveably mounted to on the body portion 3, an arm 8 moveably fitted to the boom 7, and a bucket 9 moveably fitted to the arm via a linkage 10 and having a tool point 11, which in this embodiment corresponds to the tip of the bucket 9. The tool point 11 is characterized by having a shape and a size, and hence, in this embodiment of the invention, the tool point may not be regarded as a point. Notice further that the bucket is an example of an earthwork tool, which may be used by the ground modifier 1. Use and tracking of other types of earthwork tools is within the scope of the invention. The ground modification arrangement 4 further comprises a local positioning arrangement comprising local positioning sensors 12a-c. A local positioning sensor 12d is also positioned on the rotational body portion 3 of the ground modifier 1. The local positioning sensors (12a-d) are configured to obtain local positioning information of the position of the tool point 11. In this exemplified embodiment, the local positioning sensors are inertial measuring units (IMU). However, other embodiments of the invention may use other local positioning sensors, and/or use elevation sensors in addition to local positioning sensors or instead of using local positioning sensors. One IMU is provided for each degree of mobility (DOM) of the ground modifier. As such, one IMU is positioned on the boom 7, one IMU is positioned on the arm 8, one IMU is positioned on the linkage 10, and one IMU is positioned on the body portion 3. The IMU comprises a number of accelerometer(s) and a number of gyroscope(s). Each IMU thereby provides local position information computed from accelerometer data and gyroscopic data. Notice, that other local position arrangements may be utilized to provide local position information, depending on the implementation of the invention. An example of such other optional local position sensors comprises, e.g., joint angle encoders, which would be positioned to measure joint angles of the ground modification arrangement 4. The local positioning arrangement may also optionally utilize indirect measuring of joint angles (or joint motion). This could, e.g., be implemented by, e.g., obtaining the displacement of the actuators that are configured to move parts of the ground modification arrangement, including, e.g., the arm, the boom, the bucket etc. In the case of a hydraulic excavator, the displacement actuator could, e.g., be hydraulic cylinders comprising a rod which is displaced. The displacement of rods of hydraulic cylinders may thereby optionally be utilized to compute local positioning information in some optional implementations of the invention.

The abovementioned tool point localizing module 13 of the ground modifier is positioned on the body portion 3, in this exemplified embodiment. The tool point localizing module 13 is configured to determine the position of the tool point 10, the tool point position, based on local position information received from the local positioning arrangement and specifically from the local positioning sensors 12a-d, and based on global position information received from the global positioning arrangement 6. The determined tool point position is referred to as real-time tool point position data. The tool point localization module 13 thereby repeatedly track the tool point position to establish real-time tool point position data. Optionally, the tool point localizing module 13 may further be configured to log the real-time tool point position data with a given sample frequency into a data storage (not illustrated). The data storage may optionally be included in the tool point localizing module, and/or it may optionally be included in a surface determination module, and/or it may optionally be positioned in the ground modifier and/or remote, e.g., in a data server. When the ground modifier is applied to modify a terrain or modifies a modified terrain, the tool point essentially correlates with the cut made by the bucket into the terrain or into the modified terrain during the modification of the terrain. Thereby, an individual digital modified ground surface representation may be established based on the real-time tool point position data obtained during the modification of the terrain and/or the modified terrain with the ground modifier. When two ground modifiers such as, e.g., the type of ground modifier illustrated in FIG. 10 is applied to perform ground modification, the real-time tool point position data established for each of the two ground modifiers may be utilized to repeatedly generate a digital modified ground surface representation of the modified ground surface, e.g., during the performed ground modification. Advantageously, the digital modified ground surface representation thus constitutes a surface map comprising information of where each of the two ground modifier(s) has performed terrain modifications and to which depth. The digital modified ground surface representation may be generated by a surface determination module (not illustrated) receiving tool point positions from each of the two ground modifiers. The surface determination module may optionally be located on one of the two ground modifiers. Optionally, both ground modifiers may include a surface determination module. However, optionally, the surface determination module may located externally with respect to the two ground modifiers, and hence, each ground modifier may repeatedly communicate, e.g., real-time tool point position data to the external surface determination module, and repeatedly receive generated digital modified ground surfaces.

In preferred embodiments of ground modifiers according to the invention, the ground modifier comprises a display (not illustrated). The display is configured to display at least a portion of the digital modified ground surface representation irrespective of whether the digital modified ground surface is generated on the ground modifier or is received from an external surface generation module that repeatedly generates the digital modified ground surface representation.

Optionally, the display may comprise a user interface configured to enable selecting a view of the digital modified ground surface representation. E.g., selecting between a location-based view, a full view or a earthwork tool perspective view. E.g., the location-based view triggers displaying a part of the digital modified ground surface that surrounds the actual current position of the ground modifier. Optionally, a digital representation of the ground modifier being positioned in the center of the location view. The size of the location-based view, e.g., how much of the digital modified ground surface representation that is displayed may be predetermined or it may be determined manually via the interface.

Notice that the tool point position may be determined in various ways to generate real-time tool point position data, depending on the implementation of the invention. The tool point position may, e.g., optionally be determined based on a kinematic model including the ground modifier, which in this exemplified embodiment is the ground modifier 1. The kinematic model may receive the local position information from the local positioning sensors 12a-d and may further comprise dimensional data of the specific ground modifier, e.g., the ground modifier illustrated in FIG. 10. Dimensional data may, e.g., comprise length of parts of the ground modifier. E.g., distance between the joints connecting various parts of the ground modifier. E.g., the distance between the joint connecting the boom 7 with the arm 8 and the joint connecting the boom 8 with the body portion 3. Another example of dimensional data comprises the distance between the center point of the ground modifier and the attachment of the ground modification arrangement 4.

In this exemplified embodiment, the tool point localizing module 13 is communicatively connected to the global positioning arrangement 6 and to the local positioning sensors 12a-d via wire (not illustrated). However, in other optional embodiments, the tool point localizing module 13 may be wirelessly connected to the global positioning arrangement 6 and to the local positioning sensors 12a-d.

In this exemplified embodiment, the digital modified ground surface representation is stored in a data log (not illustrated) as logged digital modified ground surface representation. In this example, the data log is included in the tool point localizing module 13. However, in other embodiments of the invention, the data log may be located on a surface determination module or elsewhere, such as on an external device such as, e.g., a data server and/or on a computing device and/or on a data storge of another ground modifier.

In this exemplified embodiment, the digital modified ground surface representation comprises global coordinates, each associated with elevation data. The global coordinates specifies a geographical location.

Optionally, the digital modified ground surface representation may comprise geodetic coordinates obtained on the basis of the local positioning data and the global positioning data.

Optionally, the digital ground surface representation may comprise metadata. Metadata may optionally include various data associated with each coordinate of the digital ground surface representation. Non-limiting examples of such data may comprise GNSS signal quality, time stamp data, color, ground compaction, ground material type etc.

In other optional embodiments, a further ground modifier may be, e.g., applied together with an excavator, and such further ground modifier may, e.g., be a bulldozer or a wheel loader. In the case of the wheel loader, the tool point 11 may be represented, e.g., by a plurality of sample points where at a bucket of the wheel loader comes into contact with a ground surface so as to modify a ground surface. Furthermore, the ground modifier may optionally be a bulldozer, in which case, the tool point may, e.g., refer to a tool point of a blade of the bulldozer. In general, the tool point may optionally, e.g., be selected such that it defines a portion of the ground modification arrangement 4 that is directly in contact with the terrain during a modification of, e.g., a ground surface and/or a modified ground surface of the terrain. This could, e.g., be the cutting edge of a bucket, a clamp shell bucket etc. The tool point may, e.g., be defined in two dimensions, e.g., the cut width or a sub-portion of the cut width of, e.g., a bucket or a clamp shell bucket. The tool point may also be defined in three dimensions. Also, the shape of a tool point may be represented. E.g., a cutting edge of a bucket may have a curved shape, which may be represented by the tool point. Notice that another example of a ground modifier is a wheel loader. Hence, the tool point may be understood as a representation of a ground modifying tool, the cutting edge of the ground modifying tool, e.g., a bucket of an excavator. A tool point position may thereby further be understood as a position of the full representation of the tool point., e.g., a full representation could, e.g., be a representation of the cutting blade of a bucket of a ground modifier, including, e.g., an excavator. The tool point positioning could be represented in various ways within the scope of the invention. E.g., by multiple digital samples representing points and/or areas of the tool point and wherein the digital samples may be sampled in a distribution across the tool point.

Optionally, the tool point localization module may be included in a data server, including, e.g. the data server described in relation to FIG. 14. The data server may optionally be positioned externally with respect to the ground modifier. In this optional implementation of the invention, the data server would be configured to receive global positioning data (sometimes referred to as global position information) and local positioning data (sometimes referred to as local position information) from one or more ground modifiers, and the plurality of ground modifiers would be configured to transmit the global position information and the local positioning information, e.g., via an onboard transmitter. Optionally, the plurality of ground modifiers may comprise a receiver configured to receive digital modified ground surface representation from the data server.

Optionally, the ground modification arrangement 4 may be arranged differently in other embodiments, e.g., be mounted on the wheelbase instead of on the body portion.

Optionally, the ground modifier may comprise two or more of the global positioning unit 6. Advantageously, this provides the possibility of determining the center point of the ground modifier. The center point may advantageously be utilized as the global position of the ground modifier and thereby the position of the tool point may be determined relative to this center point.

Optionally, the global positioning arrangement may comprise and/or be based on total stations, radio triangulation, computer vision etc.

Optionally, the illustrated ground modifier may be an excavator.

FIG. 11 illustrates a top view of an excavator 100 according to an embodiment of the invention. The excavator may be utilized to perform the terrain modification tracking method according to various embodiments of the invention, together with one or more other ground modifiers. The excavator is an exemplified embodiment of a ground modifier having an associated display 23, a tool point localizing module 13 and a surface determination module 21. The excavator 100 further comprises a wheelbase 2, a ground modification arrangement 4 moveably fixated to a body portion 3, which is moveably fixated to the wheelbase 2. The excavator 100 may be utilized as part of a ground modification system together with one or more other ground modifiers, according to various embodiments of the invention. The one or more other ground modifiers may, e.g., include the ground modifiers described in relation to FIG. 10 and FIG. 12.

The body portion 3 comprises two global navigation satellite system (GNSS) receivers 18a-b, a tool point localizing module 13 and a surface determination module. The GNSS receivers receives global position information and communicates it to the tool point localizing module 13 via wire.

The ground modification arrangement 4 comprises an inertial measuring unit (IMU) 24a positioned on the boom 7, an IMU positioned on the arm 8 and a IMU positioned on the linkage 10. A further IMU is positioned on the body portion (not illustrated). The tool point localizing module receives local position information from an output of each of the inertial measuring units. The output of each inertial measuring unit represents accelerometer and gyroscopic measurements provided from the IMU. The local positioning information is communicated to the tool point localizing module 13 via wired connection. In this embodiment, the tool point 11 is defines as the complete width of the tip (also referred to as blade or cut) of the bucket 9. The bucket 9 being an example of an earthwork tool.

The tool point localizing module 13 is configured to repeatedly generate real-time tool point position data by tracking the tool point position of the tool point 11, based on repeatedly received local position information received from the IMUs 24a-c and repeatedly received global positioning information received form the GNSS receivers. The combination of the local position information and the global position information may be referred to as positioning information.

In this example, the tool point 11 is the width of the cutting edge of the bucket 9 as illustrated by the stipulated line with arrows in FIG. 11. The actual position of all parts of the tool point may be determined in various ways, e.g., by letting the tool point position being represented as, e.g., a position of the center of the width of the tool point and by further including the complete width of the tool point in a model determining the actual position(s) of the whole width of the tool point. This model may optionally be a kinematic model, although other types of models may be utilized. In this exemplified embodiment, the tool point position refer to the whole width of the cutting edge of the bucket 9. The tool point position is tracked by the tool point localization module based on the received output from the IMU sensors and based on the global positioning information received from the GNSS receivers during the terrain modification to generate real-time tool point position data. The real-time tool point position data thereby represents the tracked positions of the tool point over the time course of the terrain modification made by the earthwork tool of the ground modifier, which in this example is an excavator 100. The real time tool-point position is received by the surface determination module 21. In this example, the surface determination module has not received tool point position data associated with other ground modifiers, and hence, the surface determination module 21 repeatedly generates an individual digital modified surface representing the modified ground surface established by the terrain modification made by the excavator 100.

The repeatedly generated individual digital modified ground surface representation is communicated to the display 23 associated with the excavator 100 and the display displays at least a part of the individual digital modified ground surface representation. In this example, a modified ground surface is generated at least once every second. This correspond to an update frequency of 1 hz. The update frequency, referring to the frequency with which the individual digital modified ground surface representation and/or the digital modified ground surface representation is generated and/or updated. By having an update frequency of substantially 1 Hz or higher, it is possible to display the generated digital surface representations, whether it being an individual digital modified ground surface representation or a digital modified ground surface representation, at a corresponding frequency. Thereby, persons watching the display 23 is provided a substantially real-time representation of the modified ground surface. Preferably the ground modifier comprises at least one transmitter and at least one receiver configured to transmit and receive, respectively, real-time tool point position data and/or individual digital modified ground surface representations. By sharing real-time tool point position data and/or individual digital modified ground surface representations among a plurality of ground modifiers, a digital modified ground surface representation representing the terrain modifications performed by each of the plurality of ground modifiers can be generated based on the shared data and be displayed on displays associated with the plurality of ground modifiers, including the illustrated display 23.

When a digital modified ground surface representation and/or an individual digital modified ground surface representation is established based the real-time tool point position data of the tool point 11 in this exemplified embodiment, the digital modified ground surface representation may thus be generated based on the width of the tool point 11, and the shape of the tool point 11, which in this example is a straight line. Other earthwork tools may have a tool point having a different shape, e.g., a curved shape, in which case the tool point may be representing the curved shape and the length of the curved shape.

### Example 1

In this example, an excavator 100 is applied to modify a terrain. Specifically, the excavator 100 is applied to remove vegetation from a terrain and to level the terrain. The excavator 100 is operated by an operator, which is a person. However, optionally, an automatic excavator that does not need an operator could be utilized according to the invention. During the modification made to the terrain by the excavator, individual digital modified ground surface representation is repeatedly generated by the surface determination module 21, based on real-time tool point position data received from the tool point localizing module 13 that tracks the tool point position of the tool point 11 based on the IMU sensors 24 and the GNSS 18a, 18b. The repeatedly generated digital modified ground surface representations represents the modified ground surface of the modified terrain that has been established based on the work performed by the specific excavator, using its earthwork tool.

When the excavator 100 starts moving towards the vegetation 17, the position of the excavator 100 is obtained by the GNSS receivers, which tracks the position of the excavator 100. When the excavator has reached the vegetation, the operator starts moving the earthwork tool and thereby the tool point, to begin modifying the terrain, e.g., by removing the vegetation, using the bucket 9 included in the ground modification arrangement 4. During this motion, the IMUs 24 provides local position information related to the tool point position of the tool point 11. Both the local position information and the global position information is fed to the tool positioning module 13, which determines real-time tool point position data representing the tool point position. By tracking the tool point position over time, the real-time tool point position data represents a trajectory of the tool point moving during the terrain modification. Since this embodiment comprises two GNSS receivers, it is possible to determine an areal center of the excavator 100. This enables the tool point localizing module 13 to utilize this areal center point of the excavator as a reference point for the position of the tool point 11. Thereby, utilizing the local positioning information received from the IMUs 24, the tool point position module 13 is tracking the tool point position of the bucket 9 to establish real-time tool point position data during the terrain modification performed by the excavator 100. The real-time tool point position data is repeatedly determined during the terrain modification.

The tool point localizing module 13 provides the determined real-time tool point position data to the surface determination module, which utilizes the received real-time tool point position data to repeatedly generate an individual digital modified ground surface.

Optionally, the ground modifier, in this example an excavator 100, includes a receiver and a transmitter configured to receive and transmit data including data such as real-time tool point position data, and/or digital modified ground surface and/or individual digital modified ground surface. This enables the ground modifier to communicate with other ground modifiers and/or to communicate with a remote surface determination module, a data server, etc. Hence, the receiver enables receiving data including individual digital modified ground surface and/or real-time tool point position data associated with one or more other ground modifier(s). When receiving such data, the surface determination module 21 of the excavator 100, generates digital modified ground surface representation that, advantageously, represent ground surface modifications made by the excavator and all other ground modifiers that has transmitted data to the excavator. Likewise, the transmitter enables the ground modifier, here an excavator 100, to transmit real-time tool point position data and/or individual digital modified ground surface representation to the mentioned one or more other ground modifiers, to enable these ground modifiers to repeatedly generate the digital modified ground surface representation and to repeatedly display at least a part of the digital modified ground surface representation.

The receiver and the transmitter may also optionally enables ground modifiers such as the excavator 100 of FIG. 11, to communicate with, e.g., a remote data server comprising a data log. Thereby, the ground modifier may transmit, e.g., digital modified ground surface representations to the data log, in order to log the digital modified ground surface representations as logged digital modified ground surface representations.

In this example the digital modified ground surface representation is repeatedly generated during the terrain modification based on the real-time tool point position data. When the terrain modification has been completed, the modified terrain now comprises a modified ground surface, which comprises no vegetation and which has been leveled.

During modification of the terrain, the established digital modified ground surface representations including the updates to the digital modified ground surface representations may optionally be automatically stored in the mentioned data log. Optionally, the the data log may be included in a data storage on the ground modifier. Optionally, the data storage may be located on an external data server.

Optionally, the tool point positioning is determined based on a kinematic model associated with the excavator 1. The kinematic model utilized the global position information and the local position information to generate the real-time tool point position data representing the position of the tool point. Optionally, the kinematic model may be included in the tool point localizing module 13.

Optionally, the tool point localization module 13 may be included as part of the surface determination module.

FIG. 12 illustrates a schematical side view of a ground modifier, which in this exemplified embodiment is an excavator 100, comprising a tiltrotator 25. The excavator may be utilized to perform the terrain modification tracking method according to various embodiments of the invention, together with one or more other ground modifiers. The excavator may further be utilized in a terrain modification tracking system together with one or more other ground modifier, according to various embodiments of the invention. The one or more other ground modifiers may, e.g., include the ground modifiers described in relation to FIG. 10 and FIG. 11.

The illustrated excavator is similar to the excavator illustrated in, e.g., FIG. 10. However, this exemplified embodiment of an excavator 100 comprises a tiltrotator 25 with an additional local positioning sensor 12d position on the tiltrotator, and a receiver 17a and a transmitter 17b and a user interface (not illustrated). The user interface comprises a display 23 and the user interface is positioned in the cab 5 so as to enable an operator of the excavator 100 to view the display 23. The display 23 is configured to display a visual rendering of at least a part of one or more digital surface representations, including digital modified ground surface representations and/or individual digital modified ground surface representations, depending on whether the ground modifier has received information related to terrain modification work performed by one or more other ground modifier(s) or not. This data may, e.g., include real-time tool point position data and/or individual digital modified ground surface representations from the other ground modifier(s). FIG. 5, FIG. 6, FIG. 8, FIG. 9a-e and FIG. 17a-e illustrates examples of a digital modified ground surface representation or of parts hereof. However, the digital modified ground surface representations may be displayed and/or rendered in a multitude of ways according to different implementations of the invention. The user interface may be configured to enable a user to select different ways of viewing the digital surface representations. E.g., optionally, the user may select between different views and different view angles and different perspectives, and the user may, e.g., select to view a part of the surface representation being closest to the geographical location of the ground modifier. The user interface may also, optionally, enable the user to zoom in and out to view specific parts of a digital surface representation. As an example, a user may, optionally, choose using the interface, to have the displayed digital modified ground surface representation displayed according to geographical location of the ground modifier.

The tiltrotator 25 adds an additional degree of mobility to the excavator 100. In particular the tiltrotator 25 enables the excavator 100 to rotate the bucket 9, and thereby the excavator is highly flexible with regards to ways it may modify a terrain. The additional local positioning sensor 12d is configured to provide local positioning data of the motion provided by the tiltrotator, while an additional local positioning sensor positioned on the body portion of the excavator (not illustrated) provides local positioning data of the rotational motion of the body portion with respect to the wheelbase. The other local positioning sensors 12a, 12b 12c, provide local position information related to the other moving parts of excavator, similar to the excavator and ground modifiers illustrated in FIG. 10 and FIG. 11, respectively.

The excavator 100 further comprises two global positioning arrangements 6a,6b and a tool point localizing module 13. The tool point localizing module 13 is configured to establish real-time tool point position data based on the local positioning information and the global positioning information. The tool point localizing module 13 is connected a surface determination module 21, which receives real-time the tool point position data. The surface determination module may further via the receiver 17a receive real-time tool point position data from other ground modifiers working to modify a terrain. Using the real-time tool point position data and the received real-time tool point position data, the surface determination module repeatedly generates digital surface representations including digital modified ground surface representations, which is then displayed on the display 23. In situations where a ground modifier does not receive either real-time tool point position data or individual digital modified ground surface representations from other ground modifiers, the surface determination module repeatedly generates an individual digital modified ground surface representation based on the real-time tool point position data from the surface localizing module 13 only, and the generated individual digital modified ground surface representation is displayed on the display 23. Thereby, during a communication breakdown, the excavator 100 is still capable of at least repeatedly generating individual digital modified ground surface representations and capable of repeatedly displaying these surface representations on the display 23. Optionally, if the surface determination module has at some point generated a digital modified ground surface representation and the ground modifier, an excavator 100 in this example, stops receiving data from one or more other ground modifiers, the surface determination module 21 of the excavator may update the digital modified ground surface representation based on its own tool-point position data to enable the updated digital modified ground surface representation to at least reflect any new ground modifications made by the excavator. When the excavator again receives data from other ground modifiers, the surface generation module 21 of the excavator utilizes these data to generate a digital modified ground surface representation that also reflect the work performed by the other ground modifier in addition to the work performed by the excavator itself.

The transmitter 17b enables the ground modifier, in this example an excavator 100, to transmit real-time tool point position data from the tool point localizing module 13 and/or individual digital modified ground surface representations generated by the surface determination module 21 to other ground modifiers. The other ground modifiers may then utilize these data together with their own similar self-collected data to generate the digital modified ground surface representation and to display that digital modified ground surface representation. The sharing of the mentioned data among ground modifiers may be synchronized so that the digital modified ground surface representation displayed on different screens associated with the different ground modifiers are substantially identical. Meaning that at any given time, the digital modified ground surface displayed on the ground modifiers sharing the mention information is substantially similar.

Notice that various types of networking technology may be utilized to communicate data via the transmitter and/or receiver, and various types of receives and transmitters may be utilized depending on the particular implementation of the invention. Examples of networking technologies that may, e.g., be utilized is described elsewhere in this disclosure, e.g., in the last part of the detailed description section.

In this embodiment, the display is connected to the surface determination via a wired connection. However, in other embodiments this connection may be wireless. Notice that mesh networking may also be applied in embodiments of the invention.

When the excavator 100 is utilized for modifying terrain, the digital modified ground surface representation is updated repeatedly over time to reflect the modified ground surface. By repeatedly transmitting the digital modified ground surface representation from the surface determination module 21 to the display 23, the operator of the excavator may follow the terrain modifications that have been performed by the operator and by other ground modifiers that would typically work to modify the same terrain.

Optionally, the user interface may be configured to enable an operator (user) to select a ground material type of a modified ground surface. The user interface may provide options of ground material types, which may be selected. When a ground material type has been selected, the ground material type may be associated with the corresponding digital modified ground surface representation established by the tool point localizing module.

Optionally, the selected ground material type may be stored together with the corresponding digital modified ground surface representation. E.g., the ground material type may be stored as metadata to the digital modified ground surface representation. This may optionally, e.g., be carried out by embedding the metadata into the digital modified ground surface representation.

Optionally, the display may display the ground material type.

FIG. 13 illustrates a tool point localizing module communicatively connected to positioning sensors and to an interface with a screen. Altogether, the illustrated components may be considered a terrain modification system that may advantageously be implemented on a ground modifier, such as on, e.g., an excavator, and thereby the system may facilitate generation of individual digital modified ground surface representations during ground modification performed by the ground modifier.

More specifically, FIG. 13 illustrates a tool point localizing module 13, local positioning sensors 12a-12n, global navigation satellite system (GNSS) receivers 18a-18n and a user interface 19 comprising a display 23. Furthermore, the tool point localizing module 13 comprises a tool point positioning determiner 20, a surface determination module 21 and a data server 22.

The tool point localizing module 13 is connected to the local positioning sensors 12a-12n and to the GNSS receivers 18a-18n. Thereby, the tool point localizing module 13 receives local positioning information from the local positioning sensors 12a-12c and global positioning information from the GNSS receivers 18a-18b. The stipulated drawing of the GNSS receiver 18n and the stipulated local position sensor 12n indicates that the system may be expanded with additional local positioning sensors and global positioning sensors. This may be advantageous, if the system should be implemented on a ground modifier having a ground modification arrangement with more than three degrees of freedom of movement, e.g., such as a multi boom excavator.

Based on the received local positioning information and global positioning information, the tool point position determiner 20 is capable of tracking the tool point positions when the tool point of a ground modifier is moving during a modification of a terrain to establish real-time tool-point position data. The real-time tool point position data is received by the surface determination module 21, which then establishes an individual digital modified ground surface representation based on the real-time tool point position data received from the tool point position determiner 20. The digital modified ground surface representation is send to the data server 22, which stores the digital modified ground surface. The individual digital modified ground surface is further send to the display 23 of the user interface 19. In this embodiment of the invention, the user interface is a computing device comprising the display 23. The computing device could be a table, a personal computer, a smart phone device or other computing devices comprising a display.

Optionally, the surface determination module may compare an elevation of a currently determined tool point position included in the real-time tool point position data with an elevation of a corresponding previously determined tool point position included in previous real-time tool point position data. Then if the elevation of the current tool point position is lower compared to the previously determined tool point position, the surface determination module updates the individual digital modified ground surface representation with the current tool point position. Hence, optionally, the tool point localizing module 13 comprising the surface determination module may perform a step of updating an individual digital modified surface representation and/or a digital modified ground surface representation when a tool point position of one or more ground modifiers has a lower elevation compared to an elevation of a corresponding tool point of a previous individual digital modified ground surface representation and/or digital modified ground surface representation, respectively. Optionally, the step is not performed when the elevation of the current tool point position is larger compared to the elevation of a previously determined tool point position at the same location. E.g. at the same global position.

The actual and measured tool point position of the physical tool will therefore be used for modification of the digital representation of how the physical ground surface is, or is at least expected to be. This digital measure is thus used for a running updating, i.e. modifying, of the digital modified ground surface representation and/or of an individual digital modified ground surface representation. By obtaining the tool point position during movement of the tool point, the trajectory of the tool may be tracked. Hence, advantageously, the digital modified ground surface representation may be based on this tacked trajectory of the tool point.

In this way, the lowest position of the tool point of a ground modifier, e.g. an excavator, is applied for on a run time basis keeping the digital modified ground surface representation updated during physical processing of a corresponding physical ground surface.

It should be noted that the updating of the digital modified ground surface representation representing a corresponding physical ground surface may be performed with “input” from 2, 3, 4 or several ground modifiers as long as these ground modifiers, and the data measured in relation to movement of the ground modifiers respective tool points at some point of time is transmitted to the system and used as a basis for updating the “shared” workspace, i.e., the digital modified ground surface. Each update of the digital modified ground surface may typically comprise updating geodetic data, e.g., including location coordinates comprising geographic location and associated elevation.

Each update of the digital modified ground surface representation may be stored with associated meta data such as time, indicating the time (e.g. including minute, hour, date and year at which the respective digital modified ground surface representation was made. A further example of metadata may include GNSS signal quality

The use of time stamps related to how a digital ground surface representation “looks” at a certain point in time will make it possible to go back in time to document when a certain part of the processing of the ground has been performed. In other words, it may be possible to visualize or somehow illustrate to a user of the system how a ground surface is/was at a given time.

Other meta data may e.g. also include type of ground surface excavated, etc. Optionally, the type of ground surface excavated is stored as meta data for each digital modified ground surface representation. Advantageously, a digital modified ground surface may then be labeled according to the ground material type. By storing the labeled digital modified ground surface representations, layers of digital modified ground surface representations may be established. These layers may thus advantageously, represent different layers of actual ground material. Advantageously, this may enable a log of the different layers that has been excavated based on the labeled digital modified ground surface representations, which is advantageous. The labeling may optionally be performed manually by selecting a ground material type on a user interface. E.g., a user interface of a ground modifier. The ground material type may be predetermined. However, the operator of the ground modifier may optionally specify a new ground material type. This may be advantageous when a ground material type being excavate is not included among the predefined options.

Further, the data server may optionally perform a step of automatically storing a digital modified surface representation only when a tool point position of one or more ground modifiers has a lower elevation compared to an elevation of a corresponding tool point of a previous digital modified ground surface representation.

In further optional embodiments of the invention, the terrain modification logging system may be implemented without the user interface 19 comprising the screen 23 ground modification computing device.

Optionally, the user interface enables an operator of the terrain modification logging system to turn on via the user interface 19 a displaying of digital modified ground surface representation on the screen 23 of the user interface 19. Optionally, when the user choose to turn of the displaying of digital modified ground surface representation, established digital modified ground surfaces may still be stored on the data server.

Optionally, the terrain modification system may be retrofitted to one or more ground modifier such as, e.g., an excavator. When implemented on a plurality of ground modifiers, this may advantageously enable the ground modifier to perform the method of the invention when the ground modifiers having the system communicates real-time tool-point position data, individual digital modified ground surface representations and/or other types of positioning data capable of comprising elevation data at geographical locations corresponding to the location of the modified ground surface modified by the ground modifiers.

Optionally, the system illustrated in FIG. 13 may be configured to enable a user to select a ground material type of a modified ground surface. Advantageously, when selecting the selected ground material type, the ground material type is associated with a corresponding digital modified surface representation of the modified ground surface as associated metadata. The metadata may optionally be stored with the corresponding digital modified ground surface representation. E.g., the metadata may optionally be embedded in the digital modified ground surface representation.

Optionally, the tool point localizing module may comprise a tool point position combinator configured to combine real-time tool point position data of a plurality of ground modifiers into combined real-time tool point position data. The combined real-time tool point position data may be utilized to generate a digital modified ground surface representation.

FIG. 14 illustrates an exemplified embodiment of a data server 22.

The data server my be applied within the scope of the invention to implement the inventive method, as a part for the inventive system, etc.

The data server 22 comprises a processor (not illustrated), memory 43 and storage 44. The data server may be utilized to automatically store digital modified ground surface representations, including combined digital modified surface representations. Optionally, the data server may comprise networking hardware, including a receiver and a transmitter, which allows the network server to communicate with ground modifiers and/or with other computing devices. The transmitters and receivers may be of various types, including, e.g., wi-fi. The storage 44 may store the data log.

Optionally the data server may comprise a surface determination module.

Optionally, the Data Server May Comprise a Tool Point Localizing Module.

FIG. 15a illustrates a surface determination module according to an embodiment of the invention. The surface determination module 21 comprises a data input DI a data output, a processor PC and memory MM. The surface determination module 21 receives real-time tool point position data via the data input DI. The real-time tool point position data is typically established by a tool point localizing module. The real-time tool point position data may be based on position information received from a plurality of ground modifiers, including, e.g., combined real-time tool point position data. Based on the real-time tool point position data, such as the combined real-time tool point position data, the surface determination module generates a digital modified ground surface representation. The generation of the digital modified ground surface representation is carried out by the processor and necessary data storage and programming information may be stored in the memory MM. The generated digital modified ground surface representation is then provided at the data output DO. In preferred embodiments of the invention, the data output DO is connected to at least two displays, of which one of these displays is associated with a ground modifier that has collected data based on which the digital modified ground surface representation was generated. The other display may also be a display associated with a ground modifier that has supplied data for the generation of the generated digital modified ground surface representation. However, the other display may also be a display utilized, e.g., by a project manager to obtain an overview of the terrain modification process.

FIG. 15b illustrates a surface determination module 21 comprising a surface combinator. The surface determination module 21 is similar to the surface determination module illustrated in FIG. 15a, except that this surface determination module further comprises a surface combinator SC. The surface combinator enables the surface determination module to combine (merge) individual digital modified ground surface representations received from different ground modifiers via the data input DI into a digital modified ground surface representation.

Optionally, the surface combinator may for geographical locations represented any two or more received individual digital modified ground surface representations compare the elevation in these overlapping geographical locations and select the lowest elevation to be utilized in the digital modified ground surface representation generated based on the received plurality of individual digital modified ground surface representations. Thereby, the generated digital modified ground surface representation represents the bottom of cut of the modified ground surface that the digital modified ground surface representation represents. The digital modified ground surface represented is transmitted via the data output to a plurality of displays, of which at least one display is associated with a ground modifier having supplied at least one of the individual digital modified ground surface representation based on which the generated digital modified ground surface representation is based.

Optionally, the surface determination module may comprise a wireless transmitter. The wireless transmitter may be connected to the data outlet. The wireless transmitter may, advantageously, communicate wirelessly with ground modifiers and/or with data servers and/or directly with displays and/or with one or more user interfaces.

Optionally, the surface determination module may comprise a wireless receiver. The wireless receiver may be connected to the data input DI. The wireless receiver may, advantageously, receive data from ground modifiers and/or from one or more data servers and or from one or more user interfaces.

Optionally, the surface determination module may comprise a tool localizing module. As an example, the tool point localizing module may, e.g., include the module illustrated in FIG. 11 or any of the tool point localizing modules exemplified in other embodiments of the invention.

Optionally, the surface determination module may comprise a data server, including, e.g., the data server illustrated in FIG. 14.

The surface determination module may be arranged on ground modifiers to enable these to generate digital modified ground surface representations and/or individual digital modified ground surface representation on board, as exemplified in various embodiments of the invention. However, the surface determination may also be used as a remote module that is located external to the ground modifiers. In this case, the surface determination unit may be utilized as a central module that receives data from ground modifiers and based on this data generates digital modified ground surface representations, which is then transmitted back to the ground modifiers, and/or to displays.

Optionally, the surface determination module may be implemented as a cloud computing module.

Optionally, the surface determination module may be implemented on one ground modifier and be utilized by other ground modifiers working on the same building site to generate digital modified surface representations and/or to generate individual digital modified ground surface representations. Thereby, only one ground modifier of all the ground modifiers on a building site is required to have a surface determination module, since any other ground modifier may communicate with the ground modifier having the surface determination module and supply, e.g., position information or real-time tool point position data. If the surface determination module comprises a tool point localizing module, ground modifiers may also transmit local position information and global position information to the surface determination module, and the surface determination module would then utilize the tool point localizing module to generate the real-time tool point position data and based on these, generate digital modified ground surface representations, which would then be transmitted back to the relevant ground modifiers and/or displays.

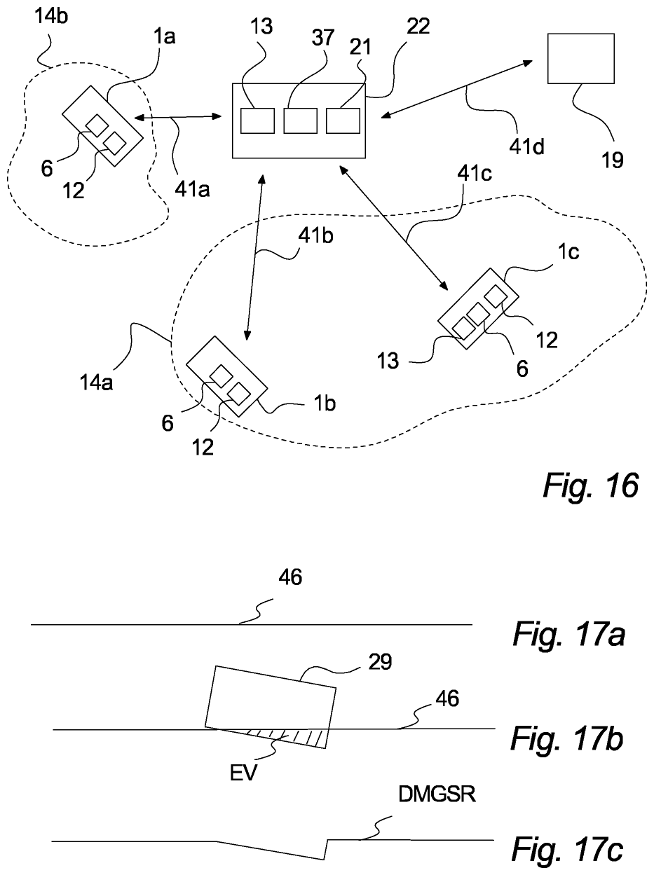

FIG. 16 illustrates communication between a data server and a plurality of ground modifiers working at two different terrains.

In this exemplified embodiment of the invention, a first ground modifier 1a is modifying a first terrain 14b. The ground modifier 1a comprises global positioning arrangement 6 and local positioning sensors 12 from which position information is obtained. The position information is transmitted via data communication link 41a to a data server 22 comprising a tool point localizing module 13, and a surface determination module SDM and a data log 37. The data server 22 may therefore repeatedly establish real-time tool point position data based on position information, such as sensor data providing, e.g., local position information and global position information, received from the first ground modifier 1a, and further, automatically repeatedly generate an individual digital modified ground surface representation based on the repeatedly established real-time tool point position data and further repeatedly store the generated digital modified ground surface representation in the data log. This may be performed repeatedly, as new positioning data is received by the data server 22. The data server 22 may optionally transmit digital modified ground surface representations of the first ground modifier via the communication link 41a to the first ground modifier. The communication link may be understood as to comprise a transmitter and a receiver and is sometimes referred to as such in other embodiments of the invention.

A second ground modifier 1b and a third ground modifier 1c is working with modifying a second terrain 14a. Similar to the first ground modifier, the second ground modifier does not comprise a tool point localizing module, and thereby this ground modifier utilizes the data server 22 to establish and store digital modified ground surface modifications based on positioning information transmitted via the data communication link 41b. The third ground modifier 1c comprises a tool point localizing module 13, and thereby is able to establish real-time tool point position data independently of the data server 22, but utilizes the data server to generate digital modified ground surface representations based on the real-time tool point position data it establishes by itself and based on the real-time tool point position data established by the data server based on position information received from the second ground modifier. Hence, the data server may generate a digital ground surface representation based on real-time tool point position data received from the third ground modifier 1c and based on position information received from the second ground modifier 1b, the data being received by the data server 22 via the data communication link 41c, and further store the digital modified ground surface representation and updates thereof generated based on data from the third and the second ground modifier.

Optionally, the data server may transmit any generated digital modified ground surface representation and/or individual digital modified ground surface representation back to the ground modifier that supplied the data based on which the digital modified ground surface representation and/or the individual digital modified ground surface representation was generated.

Optionally, the data server 22 may comprise a surface combinator module and thereby individual digital modified ground surface representations may be combined to establish digital modified ground surface representations. The digital modified ground surface representations may be transmitted via the data communications links to ground modifiers. This may typically be advantageous for ground modifier working to modify the same terrain, e.g., in this example, the second and the thirds ground modifiers 1b, 1c.

By providing a central storage by means of the data server 22, it is possible to retrieve data stored on the data server 22 via data communications links 41. In this exemplified embodiment a user interface 19 having a display (not illustrated) establish connection to the data server 22 via the data communication link 41d, to retrieve digital modified ground surface representations and/or individual digital modified ground surface representations. This may, e.g., be advantageous for, e.g., a construction manager who needs an overview of terrain modification. Further advantageously, the stored digital modified ground surface representations may advantageously be retrieved and utilized to document the performed terrain modification. E.g., it may be documented that ground material has been removed from a certain position and to a certain depth that was required. E.g., required to ensure certain construction safety standards etc.

Optionally. the second ground modifier may utilize the tool point localizing module comprised of the third ground modifier 1c to establish digital modified ground surface representations as described elsewhere in this disclosure, including in in relation to, e.g., FIG. 9a-9e.

FIG. 17-a-c illustrate different stages of a modification of a terrain and how a corresponding digital representation may be modified to correspond to the actually expected performed terrain modification.

The below FIGS. 17a-c are of course simplified but they are focused on giving an understanding of how modifications of an advantageous digital modified ground surface representation may be obtained in a relatively simple way, but also to represent validly (still an estimation, though) the actually performed earth work.

FIG. 17a shows a cross-section/side view of a digital ground surface representation 46. This digital ground surface representation 46 may of course be the result of earlier previously performed earth works and be represented by correspondingly established digital ground surface representations.

It should be noted that the illustrated view may be illustrated on a user inface such as a display in several other ways as the digital ground surface representation is continuously modified in a 3D domain in order to represent the actual terrain modification—which in real-life is 3D.

The digital ground surface representation 46 may thus of course also be visualized in different types of 2D and 3D representations, seen from different perspectives depending on what is available to a user of a user interface presenting the digital ground surface representation 46 or parts of it relevant for a user. The user interface should advantageously be available for a user of a ground modifier to facilitate the user following the progress of the earth work in real-time by looking at a visualization on a respective user interface visualizing current, past or planned digital ground surface representations at the particular/relevant geographical location.

In FIG. 17b a bucket 29 of a respective ground modifier (not shown) is shown from the from. In embodiments of the invention and explained elsewhere in the present application a digital ground surface representation is continuously modified to represent what has actually been done to the terrain by one or more ground modifiers. In an advantageous embodiment this is performed un a real-time basis by updating the digital ground surface representation to reflect a bottom off cut, i.e. the lowest measured point relevant tool points, e.g. a blade of bucket, has been positioned at a given position and preferably also at a given time.

The accumulation of all these measured positions should preferably reflect how the actual modified terrain looks as close as possible. In order to do this as close as possible, the lowest part of an applied and measured tool point may be obtained by including a 2D or 3D geometry of the actually applied tool point as already explained above. As primitively illustrated in FIG. 17b a bucket 29 is illustrated as seen from the front and both the geometry of the bucket itself is applied but also the actually position relative to the terrain and the respective digital ground surface representation 46. It is here primitively illustrated that a 2D representation of the bucket 29 is tilted with respect to the terrain and the respective digital ground surface representation 46 and thereby resulting in a corresponding to an estimated modification of the real-life terrain given by the relative geometry of the bucket, i.e. the combination of the geometry of the tool point, here the bucket, and how the bucket is moved relative to the ground surface. In FIG. 17b the geometry of the tool point the relative movement of the tool point of the tilted bucket 29 results in a corresponding modification of the terrain, here illustrated as an excavated volume EV. In other words, the dimensions of the tool applied (in particular of what is regarded the tool point), and the measured relative position to the ground surface may advantageously be applied as a basis for the run-time updating of a corresponding digital model, which is here shown in FIG. 17c as a digital modified ground surface representation.

Generally, a tool point when referred to in relation to modification of a terrain and the establishment of respective updated digital ground surface representations, may thus advantageously be referred to as the geometry of an applied tool and its respective tool point (e.g. a blade of a bucket) to the terrain/digital ground surface representation which is about to be modified and updated correspondingly in the digital model at a given (automatically measured) geographical position.

As mentioned above, an edge of a bucket (or other tool point) may have a curved shape, which may be referred to as a tool point. Notice that another example of a ground modifier is a wheel loader. Hence, the tool point may be understood as a representation of a ground modifying tool, the cutting edge of the ground modifying tool, e.g. a bucket of an excavator. A tool point position may thereby further be understood as a position of the full representation of the tool point. A a full representation could e.g. be a representation of the cutting blade of a bucket of a ground modifier (e.g. an excavator). The tool point positioning could be represented in various ways within the scope of the invention e.g. in various 2D and 3D representations.

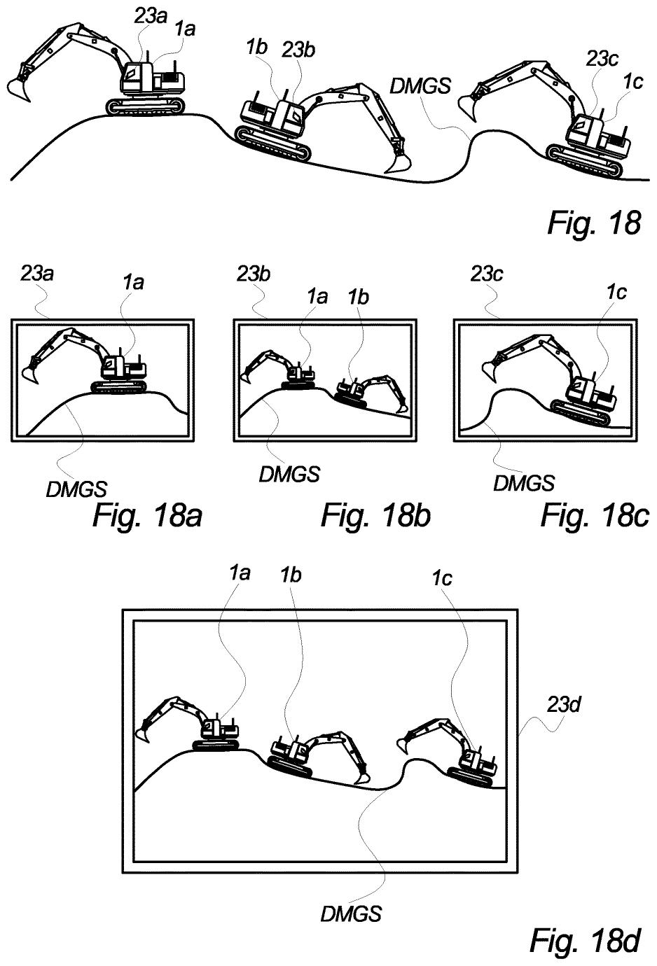

FIG. 18 illustrates a simplified version of a building site with a plurality of ground modifiers (here three ground modifiers) together working on a terrain. The result of the working is reflected in a running automated measuring of how the ground modifiers working process affect terrain and this is reflected in a digital model of the modified terrain which is updated continuously and the updated model is represented and referred to as a digital modified ground surface representation DMGS. As mentioned elsewhere in this application, the updated digital ground surface modification may be visualized and updated in a realtime basis either on by local computing, e.g. by a processor of a user interface or in the cloud or combinations thereof.

A basic present point to be made is that the updated digital modified ground surface representation DMGS may be presented in a relevant way at different displays of user interfaces 23a, 23b and 23c associated to different respective ground modifiers 1a, 1b and 1c in different relevant ways as illustrated in FIG. 18a-c e.g. automatically depending on the geographical location of the different ground modifiers 1a, 1b and 1c and or on the basis of what the user of the individual user interface wishes. This is possible because the digital modified ground surface representation DMGS includes geographical location determining the position of the updated modifications with respect to the digital modified ground surface representation DMGS.

The illustrated displays of user interfaces may thus actively support and direct users of different ground modifiers at the same time and also in real-time, thereby facilitating an easy and efficient job sharing. It may thus be easy for at user of a ground modifier to focus in on his or her actual present task but also zoom out and see what other ground modifiers are doing or whether something needs to be done.

In this context, it should be noted that actual current state of terrain may be displayed, but also that historically data may be shown and also that project data overlaying the current terrain may be shown to guide a user to earthwork about to be performed.

Moreover, a backend—typically cloud connected—may un a runtime basis be updated and follow the process of all ground modifiers on a user interface as illustrated in FIG. 18d and on a run time basis assist and direct the users of the ground modifiers in their work. The user interface 18d may here also be a “loose” interface which may be used by a local manager monitoring and planning the overall process on-site.

The following section provides further description of the invention without a reference to any one or more specific figures.

Notice that for simplicity, most embodiments involving a plurality of ground modifiers have been exemplified based on two ground modifiers. However, it is most certainly within the scope of the invention that the terrain modification tracking system and the terrain modification tracking method may involve a plurality of ground modifiers, including three or more, such as four or more, such as five or more, such as ten or more, such as 20 or more ground modifiers. In principle, there is no limit to the number of ground modifiers that may be included in the terrain modification tracking system and/or to which the terrain modification tracking method may be utilized.

Further notice that communication of data may be performed in various ways, and that any mentioned data transmission may be encrypted to avoid that data is stolen by a third party.

Further notice that the disclosed embodiments of the invention may be combined in various ways within the scope of the invention set forth by the claims.

Various embodiments of the invention comprises a transmitter and/or a receiver and/or a datalink comprising these. The transmitter and receiver may be of various different types, and hence may utilize various different technologies, including, radio transmission, and further including, e.g., Wi-Fi, low power long range wide area network technology (also referred to as LoRaWAN), narrow band internet of things (also sometimes referred to as NbIoT), and mobile cellular technology including LTE and 3G, 4G, 5G, 5G advanced, and further future variations including 6G, 7G. Also, sigFox technology, which is a very long range, but relatively low bandwidth technology, may be used. Moreover, other machine to machine (m-to-m) technologies may be applied, including machine to any computing unit such as machine to data server may also be utilized. Sometimes a transmitter and receiver may be referred to as a datalink. In principle other networking technologies may also be applied, such as Bluetooth based technologies and Z-Wave and zigbee and other nearfield technologies, although nearfield technologies may not be as desirable, because of their limited range which is typically less than the physical distance that typically is between ground modifiers that is required to communicate according to embodiments of the invention.

Optional, the network utilized for communication, including the datalink, may in some embodiment include one or more access point(s). The access point(s) may, e.g., be positioned at one or more locations on a building site.

Optionally, data that is communicated, including any type of data communicated according to the invention, may be encrypted. This includes, e.g. positioning data, digital modified ground surface representation, individual digital modified ground surface representation, real-time tool point position data, ground modifier ID, to name a few non-limiting examples of communicated data that may be encrypted.

### LIST OF REFERENCE SIGNS

1a-1c (GM1-GM2) Ground modifier
2 Wheelbase
3 Body portion
4 Ground modification arrangement
5 Cab
6 Global positioning arrangement
7 Boom
8 Arm
9 Bucket
10 Linkage
11a, 11b (TP) Tool point
12a-12d Local positioning sensors.
13 (TPL1-TPL2) Tool point localizing module.
14 Terrain
15 Ground surface
16 Modified ground surface
17a Receiver
17b Transmitter
18a-18b Global navigation satellite system (GNSS) receiver
19 User interface
20 Tool point position determiner
21 (SDM1-SDM2) Surface determination module
22 Data server
23 (DP1-DP29 Display
24a-24d Inertial measuring unit.
25 Tiltrotator
26 (DMGSR) Digital modified ground surface representation.
27 Grid points
28a-28d Grid tiles
29 Grid point section
37 Data log
39 (SC) Surface combinator
41a-41b Communication link
46 (DGS) Digital ground surface representation
100 Excavator
BS Building site
EWT Earthwork tool
DI Data input
DO Data output
MM Memory
MT Modified terrain
OLP Overlap
PC Processor
RTPD Real-time tool point position data.
TMT Terrain modification tracking system.

1.-109. (canceled)

110. A terrain modification tracking method; wherein said method comprises the steps of:
providing a plurality of ground modifiers each comprising an earthwork tool comprising a tool point;
repeatedly modifying a terrain having a ground surface using said earthwork tool of said plurality of ground modifiers, to repeatedly establishing a modified terrain comprising a modified ground surface;
repeatedly tracking a tool point position of said tool point of each of said plurality of ground modifiers during said step of modifying said terrain, to establish real-time tool point position data of each of said plurality of ground modifiers;
repeatedly generate a digital modified ground surface representation based on said real-time tool point position data of each of said plurality of ground modifiers;
repeatedly displaying at least a part of said generated digital modified ground surface representation on at least two displays, wherein at least one display of said at least two displays are associated with a ground modifier of said plurality of ground modifiers.

111. The method according to claim 110, wherein said step of repeatedly modifying said terrain comprises lifting ground material from one horizontal location to another horizontal location.

112. The method according claim 110, wherein said real-time tool point position data comprises a geographical location and an associated elevation of a tool point position, and wherein said real-time tool point position data is determined based on global position information and local position information; and wherein said local position information comprises sensor readings from one or more local positioning sensors, wherein said one or more local positioning sensors is positioned on said each ground modifier of said plurality of ground modifiers.

113. The method according to claim 112, wherein said local positioning sensors comprises one or more inertial measuring units positioned on each ground modifier of said plurality of ground modifiers.

114. The method according to claim 110, wherein said step of repeatedly generating said digital modified ground surface representation is performed substantially during said step of repeatedly modifying said terrain.

115. The method according to claim 110, wherein said step of generating said digital modified ground surface representation comprises:
generating individual digital modified ground surface representations based on real-time tool point position data for said each ground modifier of said plurality of ground modifiers; and
combining each of said individual digital modified ground surface representations into said digital modified ground surface representation.

116. The method according to claim 115, wherein said combining each of said individual digital modified ground surface representations comprises:
identifying overlapping surface regions across said individual digital modified ground surface representations; and
selecting for each overlapping surface regions elevation data having the lowest elevation to be used for said generation of said digital modified ground surface representation.

117. The method according to claim 115, wherein each of said individual digital modified ground surface representation, or each real-time tool point position data of each of said plurality of ground modifiers is distributed among each of said plurality of ground modifiers.

118. The method according to claim 117, wherein said distribution of said individual digital modified ground surface representation or said distribution of each real-time tool point position data of each of said plurality of ground modifiers comprises only distributing individual digital modified ground surface representations or real-time tool point position data representing a bottom of cut for the ground modifier of said plurality of ground modifiers associated with the individual digital modified ground surface representation or the real-time tool point position data being distributed.

119. The method according to claim 110, wherein said repeatedly generate a digital modified ground surface representation is performed on said each ground modifier of said plurality of ground modifiers.

120. The method according to claim 110, wherein said method comprises a step of comparing an elevation of each geographical location of said real-time tool point position data obtained from each ground modifier of said plurality of ground modifiers to determine real-time tool point position data comprising the lowest elevation in each geographical location; wherein said digital modified ground surface representation is established based on said determined real-time tool point position data comprising the lowest elevation in each geographical location.

121. The method according to claim 110, wherein said step of repeatedly generating said digital modified ground surface representation comprises a step of updating said digital modified ground surface, and wherein said digital modified ground surface representation is updated only at geographical locations represented in said digital modified ground surface representation having an elevation that is higher than an elevation of a corresponding geographical location of said real-time tool point position data based on which the digital modified ground surface representation is updated.

122. The method according to claim 121, wherein said step of updating said digital modified ground surface representation is only carried out when said modified ground surface and/or said ground surface is modified in a vertically downward direction, and wherein said vertically downward direction is a direction having at least a directional component corresponding to the direction of the gravitational pull.

123. The method according to claim 110, wherein said digital modified ground surface representation comprises a plurality of grid points; and wherein said plurality of grid points each represents an area of said modified ground surface, and wherein said plurality of grid points comprises elevation data associated with a real-time tool point position data from at least two different ground modifiers of said plurality of ground modifiers.

124. The method according to claim 110, wherein said displaying a part of said digital modified surface representation on a display associated with a ground modifier comprises displaying a part of said digital modified ground surface representation according to a geographical location of said ground modifier.

125. A terrain modification tracking system; wherein said terrain modification tracking system comprises:
a plurality of ground modifiers, wherein said plurality of ground modifiers each comprises:
a ground modification arrangement comprising an earthwork tool having a tool point;
a tool point localizing module(s) configured to repeatedly establish real-time tool point position data of a tool point position of said tool point;
said terrain modification tracking system further comprises:
a surface determination module configured to generate a digital modified ground surface representation based on said real-time tool point position data of each ground modifier of said plurality of ground modifiers;
a plurality of displays configured to display said digital modified ground surface representation, wherein a first display of said plurality of displays is associated with a first ground modifier of said plurality of ground modifiers; and
wherein said system is configured to perform said method according to claim 110.

126. The system according to claim 125, wherein said surface determination module comprises a tool point position combinator configured to combine real-time tool point position data of said plurality of ground modifiers into combined real-time tool point position data.

127. The system according to claim 125, wherein said system comprises a receiver configured to receive at least said real-time tool point position data and/or individual digital modified ground surface representations and/or said digital modified ground surface representation; and
wherein said system further comprises a transmitter configured to transmit at least said digital modified ground surface representation and/or individual digital modified ground surface representations and/or real-time tool point position data; and
wherein said plurality of ground modifiers comprises said receiver and said transmitter.

128. The system according to claim 125, wherein each ground modifier of said plurality of ground modifiers comprises:
a wheelbase;
a ground modification arrangement;
one or more local positioning sensors configured to provide local positioning information of a tool point position of each said ground modifier; and
a global positioning arrangement configured to provide global positioning information of said ground modifier; and
wherein said real-time tool point position data is based on local position information received from the local positioning arrangement and based on global position information received from the global positioning arrangement.

129. The system according to claim 125, wherein said terrain modification tracking system comprises a data server connectable to a network, and wherein said data server is configured to store said digital modified ground surface representation in a data log, and wherein said data server comprises a surface determination module, and wherein said surface determination module comprises said receiver and said transmitter.
